(19) United States
(12) Patent Application Publication
(10) Pub. No.: US 2020/0205360 A1
(43) Pub. Date: Jul. 2, 2020

(54) Growing Vegetables Within a Closed Agricultural Environment

(71) Applicant: 2479402 Ontario Inc., Toronto (CA)

(72) Inventor: Zale Lewis David Tabakman, Toronto (CA)

(21) Appl. No.: 16/686,559

(22) Filed: Nov. 18, 2019

Related U.S. Application Data
(63) Continuation of application No. 15/258,770, filed on Sep. 7, 2016, now abandoned.
(60) Provisional application No. 62/216,343, filed on Sep. 9, 2015.

(51) Int. Cl. A01G 31/06

(52) U.S. Cl. CPC A01G 31/06; A01C 23/042; Y02P 60/216

(57) ABSTRACT

A controlled agriculture environment containing one or more growing rooms, each containing one or more growing units is described. Each growing room is managed by an HVAC system under the control of an environmental control unit. Each growing room may have a specific temperature and humidity optimized for the type of plant or plants being room. The growing room may have a positive air pressure when compared to areas connected to it to ensure that no insects or contaminants can enter the growing room. The growing room may provide water feed, compressed air, CO₂, and electricity to each of the growing units. The growing units are also connected wirelessly to an environmental control unit.

### RELATED APPLICATION

This application claims the benefit of U.S. Provisional Patent Application No. 62/216,343, filed on Sep. 9, 2015, which is incorporated by reference in its entirety

### FIELD OF THE DISCLOSURE

The field of this disclosure includes a controlled agriculture environment containing one or more growing rooms, each containing one or more growing units.

### BACKGROUND

I. Economic Necessity for the Invention

Until the 1940s the common source for fruit and vegetables were gardens in the backyard or vegetables and produce that was in season grown on farms local to the area. In climates where there is snow several months of the year, vegetables were preserved and eaten over the winter. Rapid improvements in agriculture such as chemical fertilizers in the 1940s, faster transportation, the creation of effective and low cost refrigeration, and other technologies has changed the nature and scope of fresh vegetable agriculture into a large and big business. These changes have drastically lowered the price of food and created the massive abundance that is now take for granted. A significant impact of the improvements in transportation has been the increase in the scope of the type of vegetables eaten and expected to be available, thus creating the need for the vegetables grown by the invention.

A. Variety Requirements

Consumers expect to walk into a local grocery store and purchase vegetables common to people 12,000 miles away, all year-round, at reasonable prices. For the northern climates, this means transporting the vegetables from southern climates able to grow all year-round. Achieving abundance at affordable prices has required farriers and large agricultural companies to introduce what is colloquially called “modern farming techniques”. These are technologies enabling strawberries grown in California and delivered to all markets in North America every month of the year. The process starts from seed picking, planting, harvesting, packaging, and ends with transportation technologies enabling a strawberry to be picked (for example) on Monday in California and eaten in eastern Canada by Wednesday. The invention's ability to grow vegetables in any local area addresses this need.

The typical vegetable travels an average of 1,500 miles from where it is grown to where it is eaten. And the vegetable is expected to be bright colored, attractive, disease and blemish free. There is a significant carbon cost to moving vegetables from where they are grown and where they are eaten, such that upwards of 60% of the final product cost is the movement of vegetables.

Specifically, consumers perceive as a reflection of produce quality rank in their order of preferences: crispness and freshness, taste, appearance and condition, nutritive value, and price. Studies have shown that two factors normally enter into consumers purchase decisions: competition between like items on the display shelf, and, the acceptability of the item in reference to his or her standard for that item in reference to the above variables.

The following are selected volumes of vegetables grown commercially in the USA.

| Vegetable | Weight in Pounds |
|---|---|
| Cucumbers | 1,924,500,000 |
| Greens | 2,581,500,000 |
| Leaf Lettuce | 398,100,000 |
| Romaine | 1,924,500,000 |
| Bell Peppers | 1,998,200,000 |
| Small (Cherry, plum, etc.) | 430,100,000 |
| Tomatoes | |

### (USDA Vegetables and Pulses Outlook, September 2014, Statistics are for 2013).

In addition, in 2014 the US imported $6,593,936,000 worth of vegetables (excluding potatoes) primarily for Mexico and Canada. (USDA Foreign Agricultural Service, retrieved Aug. 9, 2015).

The following are some sample volumes produced per acre:

| | Pounds Per | Pounds Per Acre |
|---|---|---|
| Vegetable | Row | Foot |
| Arugula | 0.25 | 9,000 |
| Basil | 0.33 | 6,500 |
| Cilantro | 0.1 | 3,250 |
| Cucumbers | | 17,500 |
| Dill | 0.07 | 2,500 |
| Eggplant | 1.75 | 25,200 |
| Lettuce, Salad Mix | 1 | 7,200 |
| Parsley | 0.25 | 5,400 |
| Peppers, Red & Green | 2.5 | 36,000 |
| Sorrel | 0.35 | 7,560 |
| Spinach | 0.14 | 5,400 |
| Strawberries | 0.375 | 5,400 |
| Tatsoi | 0.3 | 10,800 |
| Plum Tomato | 5 | 36,000 |

Pounds per acre data taken from Johnny's Seed Catalogue (General), 2015, 2012 Roxbury Farm Manual (NY State). The invention's volume of vegetables per square foot addresses this need.

B. Farming Risk

With this volume of demand the farmer, is under huge pressure to produce, But weather, disease, and insects are out of the control of the farmer and can only be responded to. Mitigating these risks have led to many innovations, as well as introduced new risks and problems.

The farmer is affected by El Nino, droughts, floods, and many other major weather patterns. A farmer can only start the planting depending on the end of winter and on the soil conditions. Once planted and the crop starts to grow, a heat wave, rain storm, hail storm or some other weather pattern will damage or destroy the crop prior to harvest in just a few days.

Weather is a major contributing factor to disease, for example, while a few weeks of continuous rain will not wipe out the crop, it will encourage the growth of fungus and other diseases. Other sources of disease are insects, birds, and people who work the field. These diseases will require the use of fungicides and other forms of chemical adjustment.

Insects can destroy a crop or seriously affect the visual quality of the vegetable. The invention's ability to grow large volumes of vegetables in a protected environment addresses these needs.

C. Modern Farming

To address the requirements and risks “modern farming” techniques have been developed that fall into several broad categories a) selection of seeds, b) monoculture growing techniques, c) harvesting and packaging of the products. Each category has many details and innovations and creates new risks and challenges.

1. Seed Selection.

Selection of the seeds to use is based on many criteria, which include disease resistance, yield weight, appearance, time required for growing, how long the vegetable will last after harvest, taste and finally nutritional value. This priority order is normally driven by what is the most profitable. Taste and nutritional value needs to be last due to the realities of being profitable. The introduction of Genetically Modified Organisms (GMO) is one very effective (and controversial) technique. A seed is considered modified when a gene is artificially introduced; a GMO seed is contrasted with a hybrid seed, the traditional way to create a new cultivar through cross breeding. Farming mechanization and post-harvest processing is more cost effective when all the plants are the same cultivar. This is referred to as monoculture growing. The invention's ability to grow large volumes of vegetables locally enables the farmer to select for taste, nutritional value and still achieve the same or greater levels of profitability.

2. Monoculture Growing Techniques.

Monoculture growing techniques is the farmer's equivalent to the introduction of the assembly line as it is much easier to have acres and acres of the same cultivar growing. Monoculture allows equipment to be standardized and the processes repeated over and over again on a massive scale ensuring significant cost savings. This leads to a loss of diversity of choice for any particular vegetable. The loss of diversity means that different flavors, textures, colors are also lost. The invention allows the mechanical advantages of monoculture without the loss of diversity.

One negative impact of monoculture growing is that natural insect prevention is not available. In a mixed vegetable garden, natural insect prevention happens. In natural insect prevention the insect that is attracted to a tomato plant will eat an insect attracted to the basil plant. The insect attracted to the basil plant will eat one that likes the cucumbers, and the cucumber eating insect will eat a. tomato loving insect. Furthermore, the scents from one plant repel an insect attracted to another plant. Hence, natural occurring insect prevention exists in mixed gardens. Without this natural means of keeping out insects, Monoculture farming requires large amounts of insecticides to control insects. With the introduction of DDT in the 1940s, the world began to enjoy production levels possible without losses to insects. However, with the publication of “Silent Spring” in 1962, the use of DDT began a rapid decline with eventual banning of DDT in 1972 in the United States.

By the 1970s, the economy, consumers and food manufactures expected low cost vegetables. To achieve this, the focus moved to increasing yields per acre. A major loss in yields were to insects. Therefore, a rapid and continuous development of different types of pesticides has happened. While not necessarily proven as fact in every instance, pesticides are “felt” to be harmful to people and the environment. By law or regulation in many jurisdictions, pesticide usage must be stopped prior to harvesting with the amount of time plants are pesticide free depending on the particular pesticide, cultivar, and post-harvest handling of the pesticide. And new pesticides must become developed as insects become resistant to them. The invention does not require the use of any pesticides when fully deployed.

Monoculture continually grows the same plant which depletes the soil of its nutrients, requiring heavy use of fertilizers. Specifically, the process is that each plant needs a specific nutrient and micro-nutrient in a different amount depending on its growth stage. Plants remove these nutrients and micro-nutrients from the ground. They are replaced through the use of fertilizers. Fertilizers are designed to be used in soil, and therefore, will generally damage a plant when touching the plant. Therefore, they need to be applied prior to any substantial growth of the plant. The amount of fertilizer used by the plant and fertilizer lost to the environment is very difficult to accurately measure. Thus, the farmer typically over-fertilizes. The excess fertilization typically ends up in the water system and harms the eco-system. One well other known effect of excess fertilizer is “algae bloom” which will occur in bodies of water that farms drain into. Further, fertilizers feed weeds, which require the use of herbicides to remove. Like fertilizer, herbicides spread outside the targeted area and affect untargeted plants. There is some concern that insects such as bumblebees are adversely affected. An example of a commercial herbicide is Roundup. Like pesticides and fungicides, herbicides must be stopped prior to harvest to avoid human ingestion. The invention enables the exact amount of fertilizer to be added at exactly the correct time without any limitation on the harvesting of the vegetable canopy as the fertilizer is not ever intended to touch any part of the vegetable canopy.

Further, if a particular disease or pest can affect one single plant, then it can possible affect all the other plants as they also will be vulnerable to their attack. An infected plant, in this scenario, will be surrounded by infected plants, which will lead to the destruction of the entire crop. The invention isolates the group into smaller sections, grow plank, growing unit, and Growing Room. Each level of isolation provides additional protection against disease spread.

In a two-year study from 2011-2013, the Canadian Food Inspection Agency (CFIA) found 78.4% of non-organic samples contained pesticide residues, violating the allowable limits 4.7% of the time. Organic fresh fruits and vegetables tested across Canada in the past two years contained pesticide residue. 45.8% of samples that tested positive for some trace of pesticide and 1.8% violated Canada's maximwn allowable limits for the presence of pesticides. (http://www.cbc.ca/news/canada/manitoba/pesticide-residue-found-on-nearly-half-of-organic-produce-1.2487712, retrieved Aug. 26, 2015). From the scope of the problem it was assumed the farmers were not intentionally violating the standards, but the physical constraints of the individual farm environment that caused the results. The invention's embodiment provides a physical barrier that will stop the accrual of pesticides or other harmful airborne matter.

3. Harvesting and Packaging of the Products.

A field is directly seeded or planted with transplants. With transplants, seeds are put into trays and grow within a greenhouse. When the plants are large enough they are transferred to the field for planting. Large commercial facilities use transplanting as there is higher yields and more opportunity for automation. In colder climates, the plants may be started in a greenhouse prior to the temperature being suitable for growing.

A plant needs four elements to grow and each cultivar needs them in different quantities and different specific details. The four elements are: light, water, nutrition, and atmosphere. The planting techniques used by the farmer are designed to ensure plants receive these elements while ensuring that harvesting is cost-effective. The first factor considered is plant spacing, which essentially means the space separation of the plant from its neighbors. Plants are planted in a row; the space between rows provides space for equipment. Within a row, there are typically several plants across. The inter-row space is lost production space and, thus, the farmer needs to minimize that space to maximize yields. Within the row, space in four directions is considered to optimize light to all leaves of the plants, water to the roots, and accessing the plants at harvest. If plants are too close, rain water won't reach the roots uniformly, bottom leaves of the plants will not receive light, and depending on the plant itself, the plant may not form properly. If the plants are separated too greatly, the yields per square foot are reduced. The invention's embodiment optimizes the delivery of light, water, and nutrients to each plant thus providing the best possible growing environment,

Water delivery through rain or irrigation will be included in plant spacing consideration. Water is delivered through rain, enhanced with sprinklers or irrigation methods. Currently, world food production depends heavily on rain fed agriculture. Only 20% of the world's farmland is irrigated, but that farmland produces 40% of the world's food supply. (Howell, T. A. 2001. Enhancing water use efficiency in irrigated agriculture. Agron. J. 93, 281-289). The highest yields obtained from irrigation are more than double the highest yields for rain-fed agriculture. An advanced method of irrigation delivering fertilizer with water is called fertigation. The fertilizer is injected into the water being delivered to the plants. Large irrigation systems use “tapes” which is a long flat flexible hose placed in the rows of vegetables. The tape has small holes that release fixed amount of water to each plant. The holes are spaced in standard positioning and typically a plant will be located at each hole. The capital cost of this form of irrigation system is large and there are many technical problems, the most common being the water is not delivered because the holes are blocked by insects, fertilizer, and other debris. Another difficulty is that once the system is in place, tilling of the soil and removing dead plants can damage the irrigation system. The holes will plug and water will not be released. Further, plants must be positioned correctly with respect to each hole.

Nutrition is delivered in the form of fertilizer. Typically, the soil is fertilized prior to the planting, Once the plants are growing, it is difficult to deliver the fertilizer, and the fertilizer can damage the plants. The invention's watering system provides water directly to the roots of the plant containing the exact amount of fertilizer (nutrients).

Harvesting methods are continuous, one time, or cut-and-come-again.

In continuous harvesting, the harvesting does not destroy the plant and is repeated on some cycle suitable for the plant. This method is used for strawberries, cucumbers, tomatoes and the like as the plant continuously flowers and produces vegetables for a complete cycle.

In one time harvesting the crop is cut and the plant destroyed. Depending on the plant, the root might be harvested or handled post-harvest. Iceberg lettuce, carrots, and most other root vegetables are harvested this way.

Cut-and-come-again harvesting is traditionally used in backyard gardens or by small farmers. In this harvest method, the plant is cut above the crown. After some time, the plant regrows the vegetation that has been harvested. Almost all green vegetation plants (even celery) may be harvested this way. But the need for harvesting skills, long grow times, and short growing seasons make the method impractical for most commercial agriculture operations. “Cut-and-come-again” harvesting is an economically effective method of harvesting, as it enables the time and materials used to create a strong root structure to be reused multiple times by multiple harvests of the vegetable canopy. The invention's embodiment provides a growing environment that is economically viable to perform “cut-and-come-again” harvesting.

Harvesting of plants is either by hand or machine. When done by hand, its labor intensive, and by machine capital intensive. When choosing hand or machine harvesting, the selection is dependent on the cultivar, produce quality required, damage caused by harvesting, and plant spacing.

The time for harvesting is usually a short window before the winter season. In warmer locations, multiple harvests may be performed all year. Crop harvest must be performed at the optimum stage of maturity. Full red, vine-ripened tomatoes may be ideal to meet the needs of a roadside stand, but totally wrong if the fruit is destined for long distance shipment. Factors such as size, color, content of sugar, starch, acid, juice or oil, firmness, tenderness, heat unit accumulation, days from bloom, and specific gravity is used to schedule harvest. The result of harvesting at an inappropriate stage of development can be a reduction in quality and yield. Unfortunately, plants within a specific field will not be consistent due to factors like seeds, water distribution, and weather patterns, fertilizer distribution, to name a few items. While a target date can be estimated in well in advance, the actual date cannot be confirmed without regular and through measurements which improve the accuracy as the date approaches. Once the harvest date is set, the weather can seriously impact the ability to actually perform the harvest. For example, a severe thunderstorm would stop a harvest due to danger of the harvesters while a severe heat wave would damage the produce during the harvest. The invention allows harvesting to be performed at the optimum time to maximize the qualities demanded by the consumer.

Once a harvesting date has been determined, the time of day and the weather affects the quality of the harvested produce. Plants have dew on them and release moisture at night. Vegetables are best harvested in the cool morning hours so that they stay crisp and store longer. If harvested too late in the day, they become limp and wilt quickly, having evaporated much of their moisture and absorbed the midday heat. This is especially important for leafy greens like lettuce, chard and fresh herbs such as parsley and basil. It also applies to crisp fruiting vegetables like peas, and anything in the cabbage family like broccoli and radishes.

It has been estimated that more than 40% of perishable commodities are lost after harvesting through post production since they are living, respiring tissues that start senescing immediately at harvest. Freshly harvested vegetables are mostly comprised of water, with most having 90 to 95% moisture content. Water loss after harvest is one of the most serious postharvest conditions. Consequently, special effort is required to reduce the effects of these naturally-occurring processes if quality harvested in the field will be the same at the consumer level.

Special skills are required for proper harvesting, handling, grading and packaging of vegetables in order to insure optimum produce quality at the marketplace. It makes little difference what the quality is at harvest if it is reduced by poor handling, packaging or storage conditions. Price received for produce is determined by quality at the marketplace, which occurs after harvesting.

Harvested vegetables remain fresh through respiration. Higher respiration rates indicate a more active metabolism and usually a faster deterioration rate and may result in more rapid loss of acids, sugars and other components that determine flavor quality and nutritive value. The increased oxygen demand due to the higher respiration rates of fresh-cut products dictates that packaging films maintain sufficient permeability to prevent fermentation and off-odors. The physical damage or wounding caused by harvesting increases respiration and ethylene production within minutes, with associated increases in rates of other biochemical reactions responsible for changes in color (including browning), flavor, texture, and nutritional quality (sugar, acid, vitamin content).

Rapid cooling as soon as possible after harvest is essential to the maintenance of optimum quality. The first consideration at harvest is removal of the produce from direct sunlight, and secondly, to precool as quickly as possible. There are a number of precooling methods available a) Room Cooling, b) Pressure Cooling, c) Hydro-cooling and d) Vacuum cooling.

Room Cooling is exposure of produce to cold air in an enclosed space. This is the simplest and most common cooling method. Cold air normally is discharged horizontally near the ceiling so as to enable it to return through produce stacked on the floor. Since cooling is slow, shipments may be delayed or in some cases the product may be shipped without adequate precooling. Certain commodities, such as snap beans, may deteriorate before cooling is accomplished. These problems are minimized by ensuring that containers are stacked to facilitate good air circulation. Fans must be powerful enough to move the air at a velocity of 2 to 4 miles per hour among the containers, which should be vented adequately.

Pressure cooling is used for strawberries, fruit-type vegetables, tubers and cauliflower. It is accomplished through the use of fans and strategically-placed barriers so that cold air is forced to pass through the containers of produce. This method usually takes from ¼th to 1/10th the time required to cool produce by passive room cooling, but takes two or three times longer than hydro or vacuum cooling.

Hydro-cooling is used for stems, leafy vegetables and some fruit-type vegetables. Hydro-cooling is one of the most efficient of all methods for precooling. Produce is drenched with cold water, either on a moving conveyor or in a stationary setting. In some cases, commodities may be forced through a tank of cold water. Hydro-cooling is an excellent method for bulky items such as sweet corn, peaches, or cantaloupes. Good water sanitation practices must be observed and once cooled, the produce should be kept cold. The cold water must come in direct contact with the product, so it is essential the containers be designed and filled in such a way that the water does not simply channel through without making contact.

In vacuum cooling, commodities are enclosed in a sealed container from which air and water vapor are rapidly pumped out. As the air pressure is reduced, the boiling point of water is lowered so the product is cooled by surface water evaporation. Vacuum cooling works best with products that have a high surface to volume ratio, such as lettuce or leafy greens. The method is effective on produce that is already packaged providing there is a means for water vapor to escape. Moisture loss from the commodity is generally within the range of 1.5 to 5.0%. Generally, about 1% of the weight is lost for each 10° F. the product is cooled. The invention enables the temperature at the time of harvest through packaging to be completely controlled, thus reducing the complexity of handling and reducing the adverse effects on the product through the packaging process.

One of the major problems encountered during storage of certain vegetables is chilling injury. Another important consideration in order to maintain optimum storage conditions is relative humidity. Small fluctuations in temperature can cause wide fluctuations in relative humidity. Products stored at less than optimum relative humidity will suffer excessive water loss and begin to shrivel. Many vegetables are unacceptable for marketing if weight loss reaches 5% because of their undesirable appearance and undesirable textural changes that may accompany water loss. Leafy vegetables are among the less tolerant crops to dehydration.

Storage of different cultivars together may or may not be safe. There is a cross-transfer of odors and volatile compounds such as ethylene are emitted by sonic cultivars that may be harmful to others. Ethylene also stimulates ripening of many fruits and vegetables. This ripening effect is negligible at low temperatures (e.g., 32° F.), but it may have an effect at higher temperatures. Traditional farmers use internal-combustion engines in and around farms and the engines release some ethylene in their exhaust. Several commercially-available materials either absorb ethylene directly or convert it to inactive compounds. Certain types of activated or brominated charcoal absorb ethylene; however, some cheaper materials utilize potassium permanganate to oxidize ethylene to simple carbon dioxide and water. Manipulation of the storage atmosphere, whether in large storerooms or in small packages, can reduce the detrimental effects of ethylene. In general, reducing oxygen and increasing carbon dioxide serves this purpose and is a commercially acceptable procedure for sonic products.

A key element of food safety of commercial vegetables is traceability. Traceability is the ability to verify the history, location, or application of a vegetable by means of documented recorded identification. Traceability implies that when a consumer in New York City gets sick from eating a salad purchased locally, it will be possible to trace the salad to the manufacturer, through the supply chain to arrive at a famer in Idaho. The farmer may then check his/her records for the day when the romaine was harvested, to identify a worker, who skipped a standard procedure, and went from helping clean the pig pen to harvesting the romaine lettuce. The need for traceability strong on a farm where volumes are high and contaminants from animals, ground water, and the environment have easy access to the vegetables.

D. Hydroponics

Hydroponic Technology attempts to address many of soil-related farming shortcomings by removing the soil from the growing method. Plants are grown in containers and the roots receive the nutrients mixed in the water. A hydroponic system may be located outside or inside. The water can be recycled or disposed of after the roots receive its nutrients. In aquaponics (a variation of hydroponics), fish are grown and their waste creates the plant nutrients that feeds the plants indirectly.

There are general problems that are consistent with all types of hydroponic systems. 1) Hydroponic systems use a large number of pipes and valves to move water around. These values and pipes consistently fail and require maintenance. 2) Hydroponic systems are composed of water, light, and nutrients, in which algae flourish. The algae will clog and blog and damage equipment, and when it dies, it creates a smell. 3) The nutrients that are not taken up by the plants form salts. These salts will remain and damage the equipment, and require flushing.

Hydroponic systems are designed to circulate a nutrient solution, thus the plants at the beginning of the circulation system receive the most nutrients while the plants at the end of the system receive the least amounts of nutrients. Dissolved oxygen is the most critical nutrient and its loss depends on the amount used in the system, the greater the root biomass, and the greater the absorption of dissolved oxygen.

Hydroponic-based environments typically share one nutrient reservoir. This single reservoir means that any water born disease will be spread to the environment.

The plants are rooted in some form of grow media, also called a substrate, which holds the plant steady and allows water access to the roots. The growing chamber is the container for the root zone. This area provides plant support, as well as is where the roots access the nutrient solution. It protects the roots from light, heat, and pests. The reservoir is the component of the hydroponic system that holds the nutrient solution which is the plant nutrients mixed in water. The nutrient solution may be pumped from the reservoir up to the growing chamber (root zone) continuously, in cycles, or the roots can even be in the reservoir. The water/nutrient solution delivery system is plumbed so that the water/nutrient solution to the plants roots in the growing chamber and back to the reservoir.

Water is delivered to individual plants in a number of ways. A common method is drip emitters or sprayers similar to what is used in field irrigation. Plants absorb the nutrients and the water it needs, and leaves the rest of the nutrients in the growing medium. This may eventually cause a toxic buildup of mineral salts in the growing media or the reservoir. So flushing the excess nutrients from the root zone (growing media) with plain fresh water must be done regularly. Typically, the nutrient solution is recirculated and aerated in a central reservoir.

There are several variations of hydroponic systems each with unique characteristics: 1) Drip systems; 2) Ebb & Flow; 3) NFT; 4) Water Culture; 5) Aeroponics; and 6) Wick.

1) Drip systems are one of the most widely used type of hydroponic system. Nutrients drip on the plants roots to keep them moist. They are useful for larger plants that take a lot of root space. When using a larger amount of growing media for larger plants, more growing media retains more moisture than smaller amounts,

2) In Ebb & Flow hydroponics, the system works by periodically flooding the plants root system with nutrient solution. The main part of the flood and drain system holds the containers the plants are growing in. A tinier turns on the pump, and water (nutrient solution) is pumped through tubing from the reservoir up into the main part of the system. The Nutrient Solution continues to flood the unit until the media and roots are soaked at which point the water is released and drains back to the reservoir where it recirculates back through the system again.

3) Nutrient Film Technique (NFT) is typically used for plants like lettuce, herbs and baby greens. In an NET system a thin layer of the nutrient solution is cascaded through tubing where the bare roots of the plants come in contact with the water and absorbing the nutrients from it. In NFT systems, the plants are very sensitive to interruptions in the flow of water and wilt very quickly any time the water stops flowing through the system. While the nutrient solution flowing is very shallow, the entire plants root biomass remains moist from the roots wicking moisture on the outside of the roots, as well as through humidity that's kept within the tubing.

4) A Water Culture (or Raft) system is very effective for growing plants hydroponically. Plants are suspended in baskets located in Styrofoam or other medium (the raft) floating on the nutrient solution with the roots hanging down into the nutrient solution. A variation of the water culture system includes: a) a recirculating water culture system where the growing containers (water culture reservoirs) are connected to one central reservoir and b) the Dutch bucket method, where a plant is in a bucket filled with nutrient solution.

5) Aeroponics is the most technically challenging hydroponic system using little to no growing media. It generally uses the least amount of water. The roots get the maximum oxygen and harvesting is usually easier, especially for root crops. The plants are suspended by small baskets, or closed cell foam plugs compressed around the plants stem. These baskets fit in small holes with the roots inside the growing chamber Where they get sprayed with nutrient solution with a fine mist at regular short cycles. The regular watering cycles keep the roots moist and from drying out, while providing the nutrients the plants need to grow. The water droplet size is critical to creating a bushier root system with more surface area to absorb nutrients. Misting systems frequently clog from build-up of the dissolved mineral elements in the nutrient solution and the plants roots are vulnerable to drying out if there is any interruption in the watering cycle. The high volume of oxygen the roots get allows the plans to grow faster than they would otherwise.

6) The wick system has no moving parts and does not use any pumps or electricity. The wick uses a capillary action to wick up nutrient solution from the reservoir to the plant roots. Wick systems do not work well for plants that need to drink up great quantities of water. Wick systems are suited to smaller non-fruiting plants, like lettuce and herbs.

E. Greenhouses

A greenhouse reduces many risks associated with the weather while leveraging natural light. It is a structure with walls and roof made of transparent material such as glass or plastic. Within the greenhouse, production is soil-based or uses hydroponic technology. Soil-based production is planted in a plot of soil or in containers with soil, or a soil substitute. As an enclosed environment, insects and diseases can be better kept out. But when an infestation occurs, it can prorogate rapidly through the enclosed environment. Greenhouses become very hot in warmer temperatures and need significant ventilation. In colder temperatures, they need to be heated and are expensive to operate. Human workers and the ventilation system are the primary source for insects and diseases in a greenhouse.

F. Controlled Agriculture Environment

A Controlled Agricultural Environment (CAE) is intended to alleviate both risks associated with weather and insects. A CAE provides the optimal growing conditions throughout the development of the crop. Production is takes place in a food grade environment. The key environmental variables include a) atmosphere (Temperature+Humidity (% RH)+Airflow+CO₂), b) lighting (intensity, spectrum, interval), c) water, d) and nutrient delivery. A CAE is physically different from a greenhouse as the lighting is 100% artificial and the HVAC properties of the environment are similar to a clean room used in a semiconductor plant or a pharmaceutical manufacturing facility. A properly constructed Growing Room connected to a properly selected HVAC component of the invention will provide the physical barrier to insects, pollen, pesticides, fungicides, herbicides, airborne pathogens, and any other harmful airborne particle. The specific HVAC technology selected will provide the specific protection required for the growing environment needed.

II. Definitions.

The following definitions are not formal definitions but provide a further understanding of the embodiments of the invention.

A. Species, Cultivar and Variety.

Cultivar and Variety are two terms used by gardeners and horticulturists and are often confused. Horticulturists use the scientific designation and gardeners and farmers use the day-to-day definition. A cultivar is a general name and the variety is a specific variation that grows true to type, meaning that a plant grown from the seed of a specific variety will be similar to other plants of the variety. For example, there is a white flowering redbud that was found in nature. If a person germinates seed from this variety, most, if not all would also be white flowering. Another example is Basil which is the species. The cultivar is Genovese. The varieties include Italian Large Leat, Genovese, Eleonora and many more. Varieties are selected and cultivated by humans. Some cultivars originate as mutations on plants. Other varieties can be hybrids of two plants. To propagate true-to-type clones, many cultivars must be propagated vegetatively through cuttings, grafting, and even tissue culture. Propagation by seed may produce something different than the parent plant. Sometimes the varieties will have the same scientific name and sometimes they will be different. Different seed suppliers will name the same seed variety differently and other times they name different seed variety the same thing. The Invention's embodiment enables the development and creation of a Nutritional Formula for any Variety.

B. Canopy and Roots

Plants are divided into the canopy area and the root area. The functions relevant to the invention of the canopy (leaves and stems) include a) photosynthesis (turning light into vitamins), b) capturing CO₂, c) respiration, and d) storage of nutrients. The functions relevant to the invention of the roots are acquiring the nutrients which includes water, oxygen, nutrients (both Macro and Micro), storage of nutrients, and anchorage of the plant. The canopy and root areas are measured and monitored differently. There are many other sub-functions related to each of these major functions. The larger the root system, the healthier the plant. Each Variety of plant will have a different ratio of shoot (shoot is a measure of canopy) to root biomass as well as a different root structure. Embodiments of the invention are designed to maximize root and canopy growth which in turn will maximize the Cultivar Measurement Factors. The grow plank design addresses the needs of the root system to receive liquid, nutrients, and oxygen. The Nutritional Movement System provides the roots the nutrients required,

C. Photosynthesis

Photosynthesis is the process of capturing light energy and converting it to sugar energy, in the presence of chlorophyll using carbon dioxide (CO₂) and water (H₂O). In Photosynthesis, carbon dioxide (CO₂) from the air and water from the soil react with the sun's energy to form photosynthates (sugars, starches, carbohydrates, and proteins) and release oxygen as a byproduct. The Flexible Lighting Unit provides the light, the Atmosphere Subsystem provides the CO₂ and airflow, and the Nutrient Solution Movement System provides the liquid and the nutrients necessary for Photosynthesis to occur. The Lighting Subsystem provides the Lighting needed for Photosynthesis.

D. Respiration

Respiration is the process of metabolizing (burning) sugars to yield energy for growth, reproduction, and other life processes. Plants convert the sugars (photosynthates) back into energy for growth and other life processes (metabolic processes). The chemical equation for respiration shows that the photosynthates are combined with oxygen releasing energy, carbon dioxide, and water. In the canopy, the difference in water potential in the plant versus the surrounding air evaporates water from the plants. Gas exchange (Oxygen out and CO₂ in) is mediated through pores (known as stomata) located mainly on the lower side of leaves. These gases move in and out of the plant through the leaves by diffusion. When CO₂ levels are low inside the plant, the guard cells gain water and become turgid. They curve out, opening the stoma and allowing gases in and out. Water also evaporates through stomata. The root subsystem is part of the respiration system with scientific estimates between one-third and two-thirds of respiration occurring through the roots. The growing plank and Atmosphere Subsystem is designed to maximize Respiration in the canopy. The growing plank substrate combined with the Nutrient Delivery Formula are intended to maximize Respiration for the root structures.

The Respiration Formula is Sugar+Oxygen=Carbon Dioxide+Water+Energy. Respiration generates heat. The amount of heat given off is a function of both the respiration rate of the vegetable and the current temperature. The respiration rate doubles with each 10° C. (18° F.) rise in temperature and so the respiration rate and the heat generated by respiration is minimized by appropriate temperature management. Respiration continues after the plant has been harvested. Post-harvest, as the respiration rate increases, the shelf life decreases. In fact, temperature is considered the single most important factor affecting shelf life in the postharvest environment.

E. Transpiration

Liquid in the roots is pulled through the plant by transpiration (loss of liquid vapor through the stomata of the leaves). Transpiration uses about 90% of the liquid that enters the plant. The other 10% is an ingredient in photosynthesis and cell growth. Transpiration serves three essential roles:

1) Movement of minerals up from the root (in the xylem) and sugars (products of photosynthesis) throughout the plant (in the phloem). Liquid serves as both the solvent and the avenue of transport.

2) Cooling—80% of the cooling is from the evaporative cooling effects of transpiration. The canopy releases water through evaporation and respiration. This respiration removes water from the plant and increases the Turgor presser.

3) Turgor pressure—Liquid maintains the turgor pressure in cells much like air inflates a balloon, giving the non-woody plant parts form. Turgidity is important so the plant can remain stiff and upright and gain a competitive advantage when it comes to light. Turgidity is also important for the functioning of the guard cells, which surround the stomata and regulate water loss and carbon dioxide uptake. Turgidity also is the force that pushes roots through the soil. Turgidity is part of the “crunch” of a vegetable and it is an important element of texture which forms the concept of taste. The Atmosphere subsystem provides for the canopy respiration and transpiration needs.

F. Substrate

In nature, water and nutrients are provided to the plants “transported” through the roots located in soil, in the current embodiment the soil is replaced by a grow media or substrate to provide anchorage for the roots and presenting the nutrients to the roots. There are a number of methods which the roots use to absorb nutrients including mass flow and diffusion. The roots absorb nutrients dissolved in a liquid, which is normally water, high levels of dissolved oxygen within the liquid increases the absorption rate. Properties of the substrate can directly increase the quality and quantity of the nutrient transport. These properties include the liquid holding capacity, soil strength, Cation Exchange Capacity (CEC) (ion charge which represents its ability to hold nutrients), texture, compaction or density, pore space (which provide air holding capacity), and temperature. The scientific literature has suggested the greater the compaction of the substrate, the lesser the take up of certain minerals. The internal design of the Grow Plank 310 has a direct impact on the ability of the roots to access the nutrients contained in the Nutrient Solution.

G. Cultivar Measurement Factors

Cultivar Measurement Factors are the all the factors together used to measure the efficacy of the plants grown in embodiments of the invention. The efficacy of embodiments of the invention is measured by the health of the plants, its usability as a food, and its food safety. Plant health and usability have a large interplay and in most cases what is good for one is good for the other, but not always. The special cases are when a plant is stressed in certain ways or lacking in certain nutrients, a stressed plant will store nutrients which represents healthy vitamins for a human being. These stored nutrients affect the taste parameters. A specific Nutritional Formula can be created to maximize or minimize the value of one or more Cultivar Measurement Factors for a specific Variety.

1) The food usability factors that are measured include Taste, Visual, Texture, Nutritional Value, Scent, and Shelf Life profiling. The primarily measures include the following for taste: standard measurements of bitter, sweet, salt, sour, umami, “hot”. The Taste profile is further refined with terms like Savory, astringency, tartness. Visual factors include: color, discoloration. Texture factors include: hardiness, Cohesiveness, Viscosity, Springiness, Adhesiveness, Fracturability, Chewiness, and Gumminess (Texture is a sensory property, see Alma Sunnacka Szczesniak, Food Quality and Preference 13 (2002) 215-225). Nutritional Value includes the USDA standard measurements such as: Proximates (water, energy, protein, etc.); Minerals (Calcium. Iron, etc.); Vitamins (C, A, B, etc); Lipids (Fatty acids, cholesterol, etc.). The Scent profile includes strong, weak, sour vs sweet, and the specific scent. Shelf life, which measures how many days the product (packaged or unpackaged) can maintain usability. Some of the specific measures include oxidation level and ethelvne release.

2) The factors that are measured for plant health include the following: a) BRIX level—sugar level; b) Yield amount—the weight of a plant in a particular time; c) Canopy weight: root weight ratio; d) Leave size; e) Leave count; f) Shoot count; g) Leaf (Canopy) biomass; and h) Shoot: root biomass ratio. 3) Food Safety factors focus on the safety of the vegetables. There a significant number of pathogens with the three most widely known by consumers being e. coli, listeria, and salmonella. The primary sources for pathogens are a) the nutrients used, h) the water used as part of the nutrient solution, c) the atmosphere and d) the people working within the environment. The primary measure for pathogens looks specifically for the pathogen, the general term used when measuring pathogen's is the microbiological load.

H. Nutritional Formula

The Nutritional Formula is a specific values of Dissolved Oxygen, Nutritional Solution Temperature, Nutrient Delivery Formula, Atmosphere Formula, Lighting Formula, and the Nutrient Solution for a specific Variety to meet a specific combination of Cultivar Measurement Factors. The purpose of the Nutritional Formula is to maximize the efficacy of the Cultivar Measurement Factors primarily but not limited to taste, plant nutritional value, reduction in growing time, and increasing harvest weight. The Nutritional Formula integrates multiple harvests of the same plant over time. The Nutritional Formula is determined using the Variety Nutritional Formula Method. The Nutritional formula is anticipated to be continually adapted for a Variety, for the liquid used in a specific geographic location, and chemical analysis of the lot of the nutrients of the being used. It is anticipated that there will be multiple Nutritional Formulas for a specific Variety that will address different measurements within the Cultivar Measurement Factors. These different Nutritional Formulas will address different economic environments, different target taste profiles, nutritional profiles, or other specifications that are specific to a time or place or need. In the current embodiment the Nutritional Formula is dependent on the target Cultivar Measurement Factors, the Variety being grown, the time of day, the time in the growth cycle or time between harvests, the actual growth being achieved, the current values of the various sensors. It is known that that there is a time lag between when a Nutritional Formula value is changed and the results of those changes effect the plant. The invention enables the scientific method to be applied to the growing of any variety which will enable, by a qualified researcher, to identify potential causes and effects when growing a plant.

I. Dissolved Oxygen

Oxygen is an essential plant nutrient—plant root systems require oxygen for aerobic respiration, an essential plant process that releases energy for root growth and nutrient uptake. Oxygen requirements for plants in flower tend to be more demanding in comparison to vegetative states. The size of the root system, temperature, and nutrient uptake rates, and the specific stage of growth. Injury from low (or no) oxygen in the root zone can take several forms and these will differ in severity between plant types. Often the first sign of inadequate oxygen supply to the roots is wilting of the plant under warm conditions and high light levels. Insufficient oxygen reduces the permeability of the roots to water and there will be an accumulation of toxins, so that both water and minerals are not absorbed in sufficient amounts to support plant growth. Oxygen is delivered to the roots through the Nutrient Solution Movement System. The oxygen in liquid is measured by the dissolved oxygen (DO) level, which is vital for the health and strength of the root system as well as being necessary for nutrient uptake. Plants breathe just like all organisms via respiration. Common understanding is that plants produce oxygen from CO₂, but, the overall amount of oxygen used is dwarfed by the amount produced by photosynthesis. In embodiments of the invention, the oxygen supplied for plant root uptake is provided by dissolved oxygen (DO) located in the Nutrient Solution and as part of the Nutrient Delivery Formula. Solubility of oxygen in liquid depends on the liquid temperature, the partial pressure of oxygen, the atmospheric pressure, the salinity of the liquid and the area of liquid exposed to the air. But wider normal conditions (20 C, 1 atmosphere of pressure and air with a normal oxygen content), the maximum amount of dissolved oxygen is 9 ppm. The Nutrient Delivery Channel 110 Subsystem is the area within embodiments of the invention which adds Dissolved Oxygen to the Nutrient Solution.

J. Atmosphere Formula

The Atmosphere Formula specifies the Growing Room air temperature and humidity, Growing unit air temperature and Hwnidity, management of Growing Room VPD, and Growing Unit VPD, management of Air Flow velocity, volume direction, oxygen content, and level of CO₂. The Atmosphere Formula is delivered through the Atmosphere Subsystem with specific values for a particular Variety and the Environment Control Unit for the Growing Room or group of Grow Units 310 within the Growing Room, The Atmosphere Formula primarily is for the Inter-Harvest time period, it will be adjusted during Harvest Time

### J-1 Harvest Formula

The Harvest Formula consists of the specifications for the Growing Room Atmosphere during Harvest Time and the Harvest Cutting methodology used. The Harvest Methodology will be specific to each Variety and may be automated or be manual.

K. Lighting Formula

The Lighting Formula consists of the DLI, the specific spectrum used, the length of time a spectrum is given to the plants, the intensity of the light, and the order when each spectrum will be presented. For example, to simulate a full day light schedule, the beginning (simulated dawn) spectrum will be different than end (simulated dusk) spectrum. During the middle (simulated morning, mid-day, and afternoon) the spectrums will change. The Lighting Formula may be changed to maximize the efficacy of any Cultivar Measurement Factor for the cultivar. The Lighting Formula is unique to a Variety and Cultivar Measurement Factor. The Lighting Formula can be used to simulate any daylight sequence in the world. Thus when growing a specific type of grape, a California light or Southern France light can be simulated to enable the grape to be used for a French style wine or a California style wine. The Lighting Formula is delivered in the embodiment through the Lighting Subsystem.

L. Lumens

A Lumen is a measure of the total quantity of visible light emitted by a source. Lumens (or alternatively Foot-candles) is a “photometric” measurement based on the amount of visible light detected by the human eye, and is not intended for measuring plant photosynthesis requirements. Lumens provide an instantaneous light intensity at the time the reading is taken which provides a measure of the amount of light produced by a specific lighting system. A group of lights together can be summed up for a total number of lumens produced. As light travels in many directions it is also possible to measure the amount of light of many sources arriving at a specific spot. The distance from a point source of light, the amount of light energy diminishes according to the square of the distance (the inverse square law). Thus the difference between 12 inches and 11 inches from a light source is significantly different than the difference between 6 inches and 5 inches. Therefore, the distance from the light source and the plant is significant. The amount and specific light frequencies delivered to the plant is a form of electromagnetic radiation and varies in duration (energy over time), quality (wavelength or color), and intensity (the amount of light at each wavelength or color). Lwnens are used to measure the amount of light produced by the Flexible Lighting Unit component of the invention.

M. Photosynthetically Active Radiation (PAR)

In growing, the important measure of light is photosynthetically active radiation (PAR), current scientific literature believes PAR is best measured by light with a wavelength between 400 to 700 nm. Increasing energy in the PAR range increases plant photosynthesis, (the plant's most basic metabolic process). Each variety and cultivar crop has an optimal light intensity that maximizes photosynthesis and plant growth. Without enough light growth and quality declines; and When there if there is light beyond a specific point for a specific Variety, there is no additional photosynthesis or growth. The total amount of PAR over a specific time is computed in the DU portion of the Nutrition Formula. In summary, Lumens is the measure of the light coming from the Flexible Lighting Unit 1170 and the PAR is the measure of that light as it falls on a specific plant located in a growing plank 310.

N. Daily Light integral (DLI)

In nature, natural light continuously changes and a single measurement in time does not represent the amount of light a plant has received in a day. Instantaneous light is micromoles (μmol) per square meter (m²) per second (s⁻¹), or: μmol·m²·s⁻¹ of PAR. This “quantum” unit quantifies the number of photons (individual particles of energy) used in photosynthesis that fall on a square meter (10.8 square feet) every second. This light measurement also is an instantaneous reading Daily light integral (DLO is the amount of PAR received each day as a function of light intensity (instantaneous light: μmol·m²·s⁻¹) and duration (day). It is expressed as moles of light (mol) per square meter m²) per day (d⁻¹), or: mol·m²·d⁻¹ (moles per day). In the Nutrition Formula, a specific Variety will receive a unique DLI.

O. Nutrient Solution

The Nutrient Solution is a formula composed of a liquid, Dissolved Oxygen, temperature, and Plant Nutrients. In the current embodiment, water (H₂O) treated to remove all microbiological load is the preferred liquid. Any liquids suitable for growing a plant can be used. The specific formula changes according to the Variety being grown in the Growing Unit and the Plant Growth Stage. As the plants are continuously growing and changing they need different amounts of nutrients, thus the formula for the Nutrient Solution is continuously changed. The formula may be adjusted if the plant is receiving light (performing photosynthesis) or not. The formula is established for a particular Variety in the Variety Nutritional Formula Method. Embodiments of the invention enables the plants to receive a certain specific Nutrient Solution on a specific day within the Plant Growth Stage.

P. Nutrient Delivery Formula.

The Nutrient Solution is delivered to plants through the roots using the Nutrient Solution Movement System. The actual amount of Nutrient Solution delivered to the Grow Plank 310 is based on the pump, the number and size of the apertures in the Nutrient Delivery Channel 110, the length of time the pump is operating and the frequency the pump operates. When the Nutrient Solution is not being delivered to the Nutrient Delivery Channel 110 the Nutrient Solution provided previously to the Grow Plank Substrate will drain via gravity into the Plank Chamber 152, 154. This will allow the Substrate to dry and roots to receive oxygen. The Nutrient Delivery Formula is unique to each Variety.

Q. Cut-And-Come-Again

A method of harvesting where the plant canopy is harvested and the root structure is left alone. The plant canopy will regrow in certain amount of time which is determined with the Variety Nutritional Formula Method. Under the current embodiment, the time period ranges from 7 days to 22 days depending on the specific Variety. This method is primarily done for herbs (Basils, mints, Thyme, Rosemary, etc.) and leafy greens (e.g.: lettuces, Kales. Spinaches, Mustards, etc.). Each Variety has a specific method for harvesting.

R. Continuous Harvest

A method of harvesting where the fruit or vegetable is picked on a continuous basis. This is used, for example, in harvesting cucumbers, tomatoes, strawberries, etc.

S. Plant Growth Stage

Plant growth is separated into different stages:

a) Nursery Stage—From seed to first harvest.

b) Continuous Harvest Stage—For continuous harvest crops, the time where the vegetables are harvested.

c) Inter-harvest Period—From Harvest to Harvest. This time period can be between 7 and 22 days for Cut-And-Come-Again harvested crops. The Inter-Harvest Period is measured in days, and the Nutritional Formula is modified to reflect the number of days after a harvest and before the next harvest. The plant needs recovering time immediately after each harvest. Each Variety is known to have a different recovery time period. The efficacy of the Nutrients is governed by the Atmosphere Formula, the Lighting Formula, and the pH value of the Nutrient solution.

T. Nutrients

Nutrients refer to Macro-Nutrients and Micro-Nutrients needed by the plant. The terms Macro and Micro refer to the relative volume of the elements within the Nutrient Solution. The percentage of a specific macro-Nutrient is significantly higher than the micro-nutrient. The amounts of a specific nutrient are dependent on the amount expected in the harvested cultivar and variety plant as well as a ratio between certain elements, Each Variety has a unique and specific amount of Macro and Micro Nutrients depending on which Cultivar Measurement Factor being optimized.

U. Macro-Nutrients and Micro-Nutrients

Macro-Nutrients include: Carbon (C), Hydrogen (H), Oxygen (O) provided by the air and as CO₂ through the Atmosphere Subsystem and water (H₂O) in the Nutrient Solution. Explicitly added in the Nutrient Solution is Nitrogen (N), Phosphorus (P), Potassium (K), Calcium (Ca), Magnesium (Mg), and Sulfur (S). The Micro-Nutrients added to the Nutrient Solution include Boron (B), Chlorine (Cl), Copper (Cu), Iron (Fe), Manganese (Mn), Molybdenum (Mo) and Zinc (Zn). The specific amounts and the ratio of each element to each other are specific to a Nutritional Formula for a Variety.

V. pH

pH stands for potential hydrogen, it is the measure of the activity of the solvated hydrogen ion in a solution and indicates the degree the Nutrient Solution is acidic, neutral or alkaline. The pH scale goes from 0 to 14, 7 is neutral, any values below 7 are acidic, and any values above 7 are alkaline. The pH scale is logarithmic and each whole pH value below 7 is ten times more acidic than the next higher value. Thus pH 4 is ten times more acidic than pH 5 and 100 times (10 times 10) more acidic than pH 6. Plants growing in soil typically grow best in a pH value between 6.0-7.0. When outside the range of 5.5-7.0 nutrients become less accessible for plants. Each Variety absorbs nutrients differently and the ability of the Variety to absorb a specific nutrient is affected by the pH level of the Nutrient Solution. The current embodiment of the invention enables the pH value of the solution to be adjusted. The raising and lowering of the pH is caused by adding a solution that may possibly contain nutrients used by a plant.

W. EC and TDS

Electrical conductivity (EC) is the measure of a material's ability to allow the transport of an electric charge measured in Conductivity Factor (CF) or Micro Siemens per square centimeter (MS/cm²) conductivity or Parts per Million (PPM). It represents all the ions in the Nutrient Solution and provides a general number of how much nutrient is in a mix. However, it does not distinguish between any specific nutrient and thus is only useful as an approximation of relative Nutrient Solution density. TDS stand for total dissolved solids and refers to the measure of all nutrient ions contained in a liquid. It is a measurement used to determine nutrient strength. TDS is not as accurate a representation of EC but much more commonly used. TDS is directly calculated from Conductivity using one of two different scales: NaCl (1EC=500 ppm) and the 442 scale (1EC=700 ppm). Different meters offer different conversion factors and some offer a sliding scale or the option to change the scale. An EC reading must be adjusted for temperature. EC/TDS is used as a general measure by embodiments of the invention to monitor the amount of nutrient in the nutrient solution at a particular time.

X. Ion Selective Measurement

Ion-selective electrodes (ISE) consist of an ion-specific half-cell and a reference half-cell. The ion-specific cell gives a potential against the reference cell depending on the specific ion concentration. When the specific ion concentration (the sample or an ion standard) changes, the potential changes as well. Current ion-selective measurement becomes distinctly inaccurate in the presence of many different ions, such as can be found in the Nutrient Solution, thus rendering it a potentially inaccurate method for knowing the specific ppm of a particular nutrient. In the current embodiment, an ISE probe, or a device performing a similar action, will report a PPM of an ion. Using stored reference values computed adjustments) the value returned by the probe may be used monitor the amount of a specific ion in the nutrient solution.

Y. Vapor Pressure Deficit (VPD)

Vapor Pressure Deficit or VPD is a measure of the difference (or deficit) between the pressure exerted by the moisture currently in the air and the pressure at saturation. VPD units are most often expressed in standard pressure units such as millibars, kilopascals, or pounds per square inch. VPD is sometimes expressed in mass deficit concentration units such as grams of water per cubic meter of dry air, or crams of water per kilogram of dry air. VPD measurements can provide an indication of the current evaporation potential of the air, and is useful in creating the correct atmosphere for growing the plants. VPD value is useful when air temperature or humidity changes as reflects the evaporation potential. VPD can be effected by airflow as well. In the embodiments of the current invention, VPD values can change at different heights in the plank due to the effect of the evaporation by the plants, Growing Room atmosphere (outside air or internal recirculated air) controlled by the Environmental Control Unit 1010, heat and vapors from the Lighting Subsystem, atmosphere (air and/or CO₂) made available to the growing Planks 310 under control of the Atmosphere Subsystem, or atmosphere effected by the various chambers storing the Nutrient Solutions. VPD is part of the overall Nutritional Formula to manage, predict, and control plant evaporation. Plants control decisions to shade, or to increase and decrease liquid take-up using its understanding of the VPD value. This affects Nutrient Solution take-up resulting in the amounts of nutrients absorbed by a plant, which will increase the vitamins and the weight of the plant. In this embodiment, VPD is controlled in a much greater manner than in field or greenhouse conditions. The VPD value can be used to measure and create or reduce crop stress. Management of the VPD value is part of a complete and comprehensive and specific Nutrition Formula for a particular cultivar and a particular variety.

Z. Airflow

The airflow refers to the movement the air in the plant canopy. The airflow requirement is specific for a Variety. Too high an airflow will increase plant Respiration rate beyond the Transpiration rates and cause plant stress. Too low an airflow will reduce transpiration and effect the efficacy of the Cultivar Measurement Factors. The airflow is managed by the Atmosphere Subsystem. Airflow can be used to create a “wind” like environment which will affect the turgidity of the plant which affects the “crunch” of certain leafy vegetables. The airflow system can also be used to release the CO₂ directly into the canopy area.

Many fruiting plants require pollination. In the wild they require wind, insects, and or animals. The density of the planting in embodiments of the invention enables an increased airflow to act as simulated wind for pollination. The efficacy of this method is dependent on the Variety. The airflow within the invention is strong enough to assist in the pollination of the plants.

AA. Root Environment

Prolonged light will damage plant roots, and high temperature in the root zone will cause heat stress to plants, as well as fruit and flower drop as a result of heat stress. The growing plank 310 is designed to limit light into the root zone while providing access to air and temperature control.

BB. Physiological Effects of Harvesting

Harvesting of fruits and vegetables increases their perishability through increased respiration rates, altered ethylene production rates, and increases in other biochemical reactions: discoloration and color, texture, aroma and flavor, nutritional quality The degree of processing and the quality of the equipment (i.e. blade sharpness), significantly affect the wounding response. Damage to cells near cut surfaces influences the shelf life and quality of the product. For example, lettuce cut by a sharp knife with a slicing motion has a storage life approximately twice that of lettuce cut with a chopping action. Shelf life of lettuce is less if a dull knife is used rather than a sharp knife. Strict temperature control is required to minimize the increased respiration rates of harvesting.

CC. Post-Harvesting Production Methods

Post-harvest production methods are critical to extending shelf life. Cooling crops immediately after cutting removes sugars and other nutrients at the cut surfaces that favor microbial growth and tissue discoloration. Because of differences in composition, some crops such as cabbage are known as “dirty” products because they release substantially more organic nutrients with harvesting. For lettuce, discoloration of the cut surfaces is a major quality defect. Cutting stimulates enzymes involved in phenolic metabolism which in turn leads to the formation of undesirable brown pigments. To ensure packaged salad products with no brown edges, very low O₂ (<0.5%) and high CO₂ (>7%) atmospheres are used commercially. These conditions may lead to increases in acetaldehyde and ethanol concentrations, indicating a shift from aerobic to anaerobic or fermentative metabolism. These changes are greater in the iceberg lettuces than in romaine lettuces, and are correlated with the development of off-odors.

DD. Harvesting: Leaf Size

Young leaf tissue will have higher respiration rates than mature fully developed leaves. 2×2 cm pieces from mature leaves have respiration rates almost double those of the intact leaves, but similar to rates of the small leaves. In the scientific literature, shredding mature leaves approximately doubled respiration rates. Different parts of a vegetable may have very different respiration rates as illustrated with data from broccoli. The respiration rates of iceberg and romaine lettuces cut as pieces (2-3×2-3 cm) are 20-40% higher than rates of the respective intact heads. The respiration rates of shredded lettuce and shredded cabbage are 200-300% greater than those of the intact heads and remain high throughout the storage period. Respiration rates and deterioration rates can be minimized by quickly cooling the product and storing at 5° C. (41° F.) or below. Selecting a Variety and a Nutritional Formula enables the maximum efficacy for leaf size respiration.

EE. Modified Atmosphere Packaging (MAP)

Although temperature is the principal controlling factor for respiration rates, modified atmospheres will also reduce metabolic rates. Controlled atmospheres of 1-2% O₂+10% CO₂ reduced respiration rates of minimally processed strawberries, peaches and honeydew by 25 to 50% at 5° C. These same atmospheres also reduced ethylene production and softening of the fruit tissues. Control of the wound response is the key to providing good quality. Low temperatures minimize differences in respiration and ethylene production rates between the cut and the intact product. Low temperatures are also essential to retard microbial spoilage on cut surfaces. Variety, production conditions, stage of maturity, piece size, and storage conditions all contribute to variations in fresh-cut product physiology. Although MAP maintains visual quality by retarding browning, off-odors increase and lettuce crispness decreases during storage of the salad products.

FF. Packaging Technology

Packaging technology is indispensable for most fresh harvested crops. The selection of the plastic film packaging material strives to achieve equilibrium between the oxygen demand of the product (oxygen consumption by respiration) and the permeability of the film to oxygen and carbon dioxide transmission. In practice, films are often selected on the basis of the oxygen transmission rate (OTR expressed in units of ml/m²-day-atm). Several product factors need to be considered in selecting film packaging: the rate of respiration of the product and the specific cut, the quantity of product, and the desirable equilibrium concentrations of O₂ and CO₂. Plastic film characteristics that need to be considered include: 1) the permeability of a given thickness of the plastic film to O₂, CO₂ and water at a given temperature; 2) total surface area of the sealed package; and 3) the free volume inside the package.

With current packaging technology, it is possible to have product of good visual quality even at temperature-abuse conditions. Although product temperatures of 20° C. (68° F.) are unlikely, short periods near 10° C. (50° F.) can readily occur. The visual quality of the product is only slightly reduced by holding at 10° C. (50° F.), but atmosphere composition, production of fermentative volatiles and off-odor development are notably different from product stored at 0° C. (32° F.). These data underscore the potential of low temperature storage in conjunction with appropriate MAP conditions. In the case of lettuce, the atmospheres effective in retarding cut edge browning are very different from the atmospheres recommended for intact lettuce heads (lettuce develops the disorder brown stain when to CO₂>2%). Green bell peppers provide another example in which modified atmosphere conditions beneficial for the fresh-cut product differ substantially from those recommended for the intact product. As more research is conducted on Varieties the temperature and atmosphere requirements will be specifically determined for each Variety. A Variety with a specific respiration rate may be selected for a specific film or a film can be selected and the Variety with a specific respiration rate may be selected.

Many types of films are commercially available and used for fresh-cut packaging, including polyethylene (PE), polypropylene (PP), blends of PE and ethylene vinyl acetate (EVA), and co-extruded polymers or laminates of several plastics. Besides the permeability characteristics described above, films must also satisfy other requirements (Zagory, 1995). They must have strength and be resistant to tears and splits (oriented PP or polystryene), punctures (low density PE), stretching (oriented PP or polyethylene terephthalate), slip to work on bagging machines (acrylic coatings or stearate additives), have flex resistance, clarity and printability, and in some cases resealability (Ziploc or sticky seals). Consumer tactile appeal and ease of opening are also important considerations. Film selection is a compromise between the strengths and weakness of the different materials. Many currently used films are co-extrusion or laminates of several kinds of plastics, each providing a specific benefit. Recent advancements in controlling the chain length of plastic polymers have resulted in high OTR films with superior strength, good clarity and rapid sealing. Rapid sealing is extremely important for high volume form-fill-seal packaging equipment. Bags are usually checked periodically on the processing line for seal integrity (in a water filled pressurized chamber) or “leakers”. There can be considerable variability in O₂ concentrations in well-sealed salad bags, perhaps due to slight variations in film permeability during the manufacturing process.

Other packaging options include rigid impermeable trays covered with a permeable film or membrane patch. Micro-perforated films provide very small holes (40 to 200 μm) and allow elevated levels of O₂ in combination with intermediate CO₂ concentrations, With temperature fluctuations, the permeability of most common films changes very little in comparison to the dramatic increases in respiration rates (oxygen demand) at warmer temperatures. With lack of oxygen, anaerobic metabolism occurs resulting in off-odors and other quality problems. Anti-fog films capable of dispersing water droplets to avoid condensation, incorporation of antimicrobials in films, and use of time-temperature indicators on or incorporated into plastic films are also relevant.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic view of a growing room.

FIG. 2 is a schematic view of a growing unit.

FIG. 3 is a conceptual view of a growing unit.

FIG. 4 is a plan view of a nutrient solution reservoir.

FIG. 5 is an elevation view of a growing unit from the growing side.

FIG. 6 is an elevation view of a growing unit from the front.

FIG. 7 is a plane view of a nutritional delivery channel.

FIG. 8 is an elevation view of a growing plank lock.

FIG. 9a is an elevation view of a sandwich-design growing plank from the side.

FIG. 9b is an elevation view of a homogeneous-design growing plank from the side.

FIG. 10a is elevation view of a sandwich-design growing plank from the end,

FIG. 10b is elevation view of a homogeneous-design growing plank from the end.

FIG. 11 is a plan view of a flexible lighting unit.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments of the invention include a system composed of a Controlled Agriculture Environment containing one or more Growing Rooms, each containing one or more Growing Units.

Each Growing Room 1000 is managed by an HVAC system under the control of the Environmental Control Unit 1010. Each Growing Room 1000 may have a specific temperature and humidity specific for the Variety. The Growing Room may have a positive air pressure when compared to areas connected to it. The positive air pressure is specifically to ensure that no insects or contaminants enter the Growing Room. The Growing Room may provide water feed, compressed air, CO₂, and electricity to each of the Growing Units 1030,1032, 1034. The Growing Units 1030,1032, 1034 are connected electronically (via wire or wirelessly) to the Environmental Control Unit 1010. The Environmental Control System connects to a Central Control System 1005. Thus all Growing Units in all Growing Rooms are a connected single system. This central system enables central monitoring of all growing units no matter where they are located in the world. Furthermore, all probe reporting is provided to a central location, if a probe reports an out of normal condition that situation can be identified and addressed.

I. OVERVIEW OF THE FIGURES

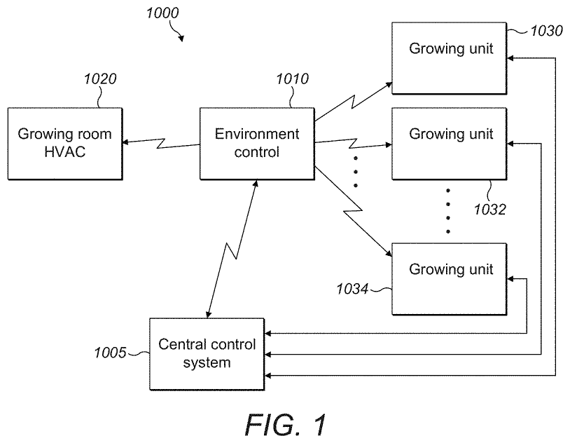

Turning to FIG. 1, shown is schematic view of a growing room 1000. An environmental unit 1010 controls a growing room HVAC unit 1020 and a multitude of salad growing units 1030, 1032, 1034. The environmental unit is controlled by the Central Control System 1005.

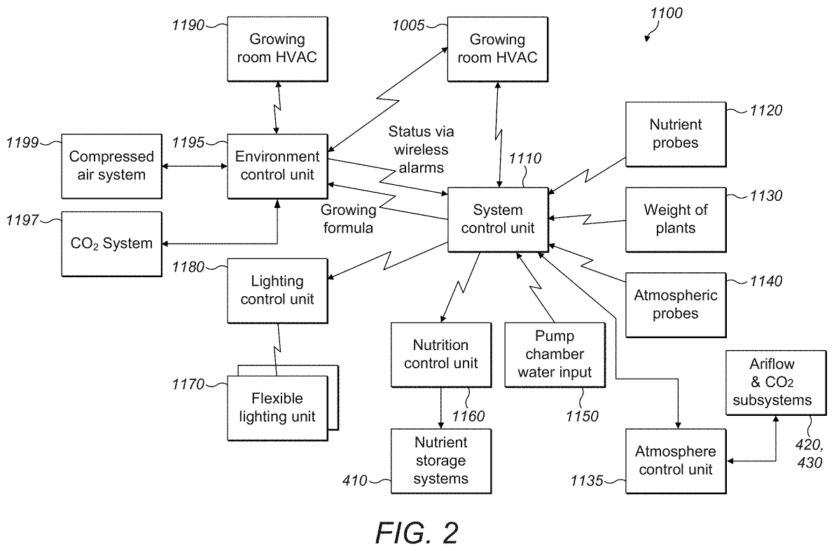

Turning to FIG. 2, shown is a Growing unit system control unit schematic 1100. A system control unit 1110 interfaces wirelessly with an environmental control unit 1195, which itself interfaces with a growing room HVAC 1190. The system control unit 1110 also interfaces with a lighting control unit 1180, which itself interfaces with a flexible lighting unit 1170. The system control unit 1110 also interfaces with a Nutrient Control System 1160, which itself interfaces with the Nutrient Storage Units. The system control unit 1110 also interfaces with a pump chamber water input 1150. The system control unit 1110 also interfaces with atmospheric probes 1140. The system control unit 1110 also interfaces with the weight of the planks 1130. The system control unit 1110 also interfaces with nutrient probes 1120. The System Control Unit also interfaces with the Central Control System 1005 directly or through the Environmental Control Unit 1010. The Central Control System 1005 also interfaces with the environmental control unit 1195. The Central Control Unit also interfaces with the Atmosphere Control Unit which itself interfaces with the CO₂ delivery system 430 and the airflow system 420.

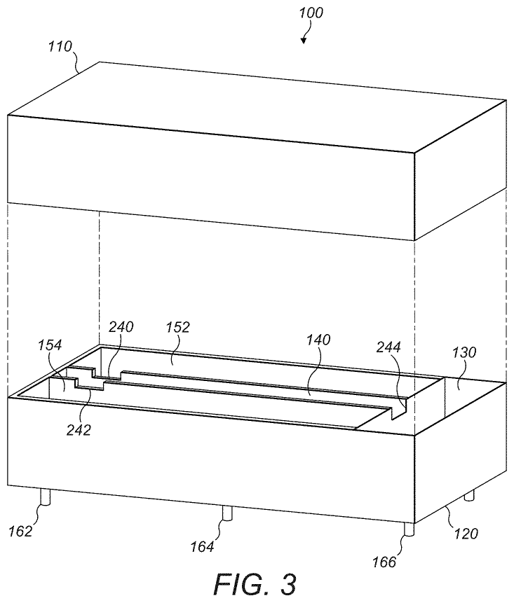

Turning to FIG. 3 shown is conceptual view of a growing unit. The growing unit 100 is shown without growing planks, flexible lighting units, dividers, or a system control unit. Shown is a Nutrient Delivery Channel 110, a Nutrient Solution Reservoir 120, a Nutrient Pumping Chamber 130, a Catchment Chamber 140, the two Plank Chambers 152, 154, and a number of Adjustment Legs 162, 164, 166, 168. The Weirs 240, 242, 244 are shown as well.

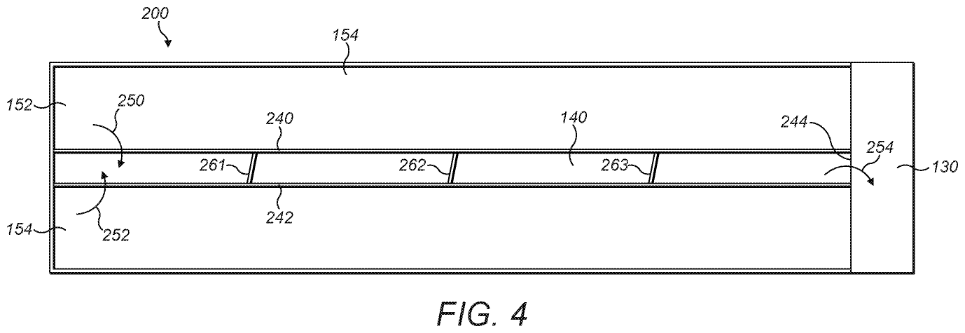

Turning to FIG. 4, shown is a plan view of a Nutrient Solution Reservoir 120. Shown is a Catchment Chamber 140, Plank Chambers 152, 154, a Pump Chamber 130. Weirs 240, 242. are placed between the Catchment Chamber 140 and the two Plank Chambers 152, 154. A Weir 244 is placed between the Catchment Chamber 140 and Nutrient Pumping Chamber 130. Nutrient Solution Movement 250, 252 occurs by flowing nutrients into the Catchment Chamber 140 over Weirs 240 and 242, through Dividers 261, 262, 263. The Nutrient Solution Movement 254 continues in the Pump Chamber 130 over the Weir 244.

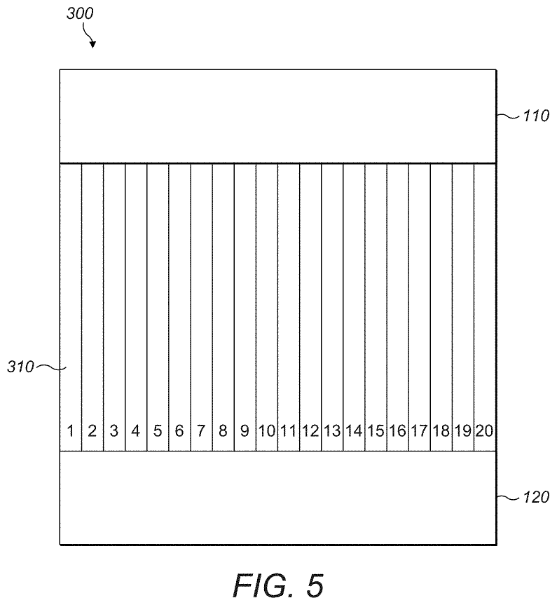

Turning to FIG. 5, shown is an elevation view of a growing unit from the growing side 300. The plant details and flexible lighting units are not shown. Shown is the Nutrient Delivery Channel 110 connected by a number of growing plank 310 and ending at a Nutrient Delivery Reservoir 120.

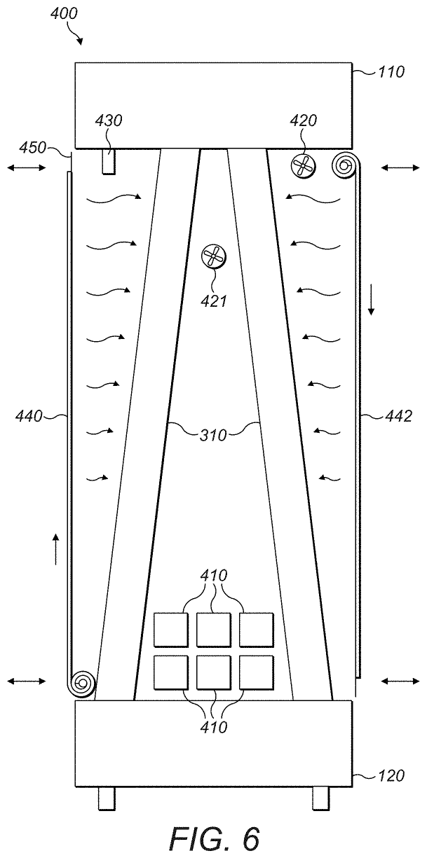

Turning to FIG. 6, shown is elevation view of a growing unit from the front 400. Growing Planks 310 run from the Nutrient Delivery Channel 110 to the Nutrient Solution Reservoir 120. Nutrient Storage Units 410 are in between the Growing Planks 310. Airflow distribution (fans or other methods for distributing and directly air) 420, 421 are placed in front or behind the Growing Planks 310, or on the Flexible Lighting 440. A CO₂ Release Location 430 is placed on the side of the Growing Planks 310 or on the Flexible lighting 440. Flexible lighting 440, 442 is placed on the sides of the unit and may be selectively deployed over those sides by a Pull Wire 450, 452.

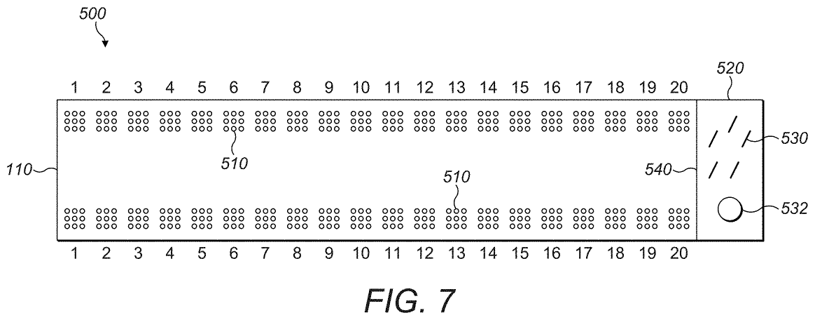

Turning to FIG. 7, shown is a plane view of a nutritional delivery channel 500. Above the Nutrient Delivery Channel 110 are a plurality of apertures 510 used to let the nutrient solution into the growing planks. A Probe Chamber 520 accommodates a plurality of probes 530, 532 and is separated by a Weir 540.

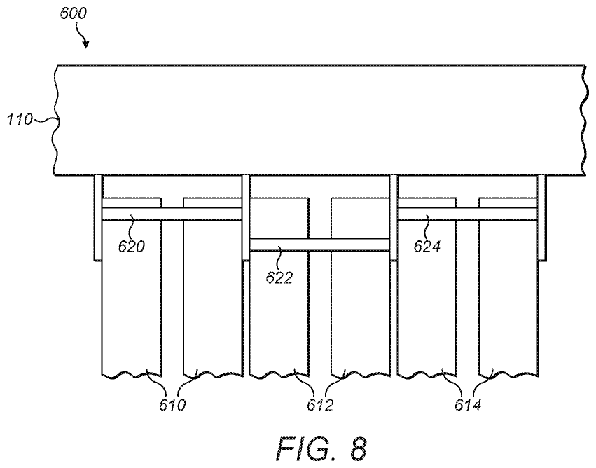

Turning to FIG. 8, shown is an elevation view of a growing plant lock 600. From the Nutrient Delivery Channel 110 are growing planks 610, 612, 614 and locking units 620, 622, 624.

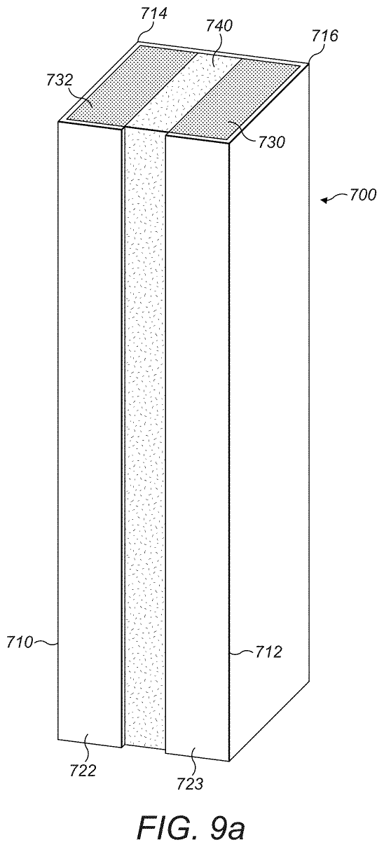

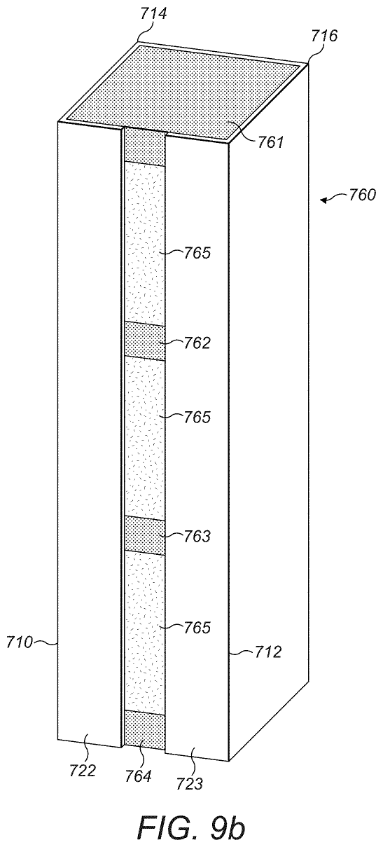

Turning to FIG. 9a, shown is an elevation view of a sandwich-design growing plank 700 with no plants shown. A multitude of fold points 710, 712, 714, 716 define the corners of the frame 810 and reflective material 722, 723 is on the front of the planks. The plank includes inert grow media 730, 732 on the outer sides of the plank and soilless media 740 in the inner core of the plank.

Turning to FIG. 9b, shown is an elevation view of a homogenous-design growing plank 760 from the side with no plants shown. A multitude of fold points 710, 712, 714, 716 define the corners of the frame 810 and reflective material 722, 723 is on the front of the plank. The plank includes a plurality of inert grow media 761, 762, 763, 764 on the top, middle, and bottom, of the plank and soilless media 765 in the remaining parts of the plank

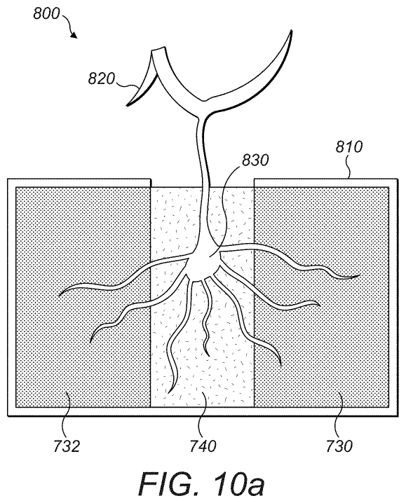

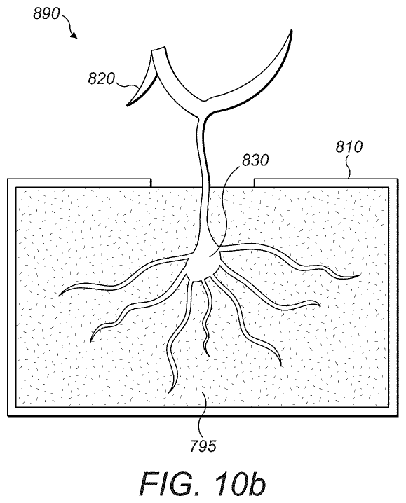

Turning to FIG. 10a, shown is an elevation view of a sandwich-design growing plank from the end 800. The plank is surrounded by a frame 810. A plant 820 and root structure 830 is implanted in the soilless media 740 in the inner core of the plank with inert grow media 730, 732 on the outer sides of the plank.

Turning to FIG. 10b, shown is an elevation view of a homogenous-growing plank from the end 890 without the inert Grow Material 761. The plank is surrounded by a frame 810. A plant 820 and root structure 830 is implanted in the soilless grow media 795 with inert grow media at the top and bottom and zero or more pieces in the middle of the plank.

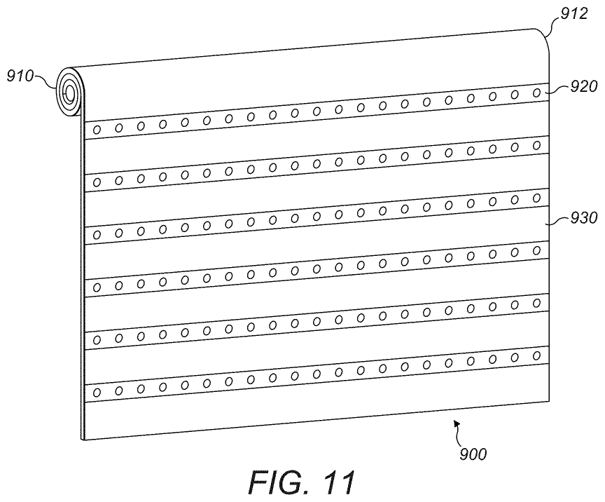

Turning to FIG. 11, shown is a plan view of a flexible lighting unit 900. The unit may be selectively installed or de-installed by rollers 910, 912. Installed on the unit are LED strips 920 that may horizontal or vertical. In FIG. 11, the horizontal method is displayed. The number and placement of the LED strips 920 may be varied as circumstances warrant. The underlying surface 930 of the unit may be white or reflective Mylar or other material as needed for growing needs.

II. DETAILED REVIEW OF THE EMBODIMENTS

A. Central Control System

A Central Control System 1005 is physically separate from all Growing Rooms 1000 and controls all Environmental Control Units 1010 and all Growing units 1030, 1032, 1034. The Central Control System provides and updates the specific Nutritional Formulas. Thus all Growing units in all Growing Rooms can be a connected single system. The Central Control System 1005 receives all System Control Units 1110 located in all Growing units 1030,1032,1034, no matter where they are located in the world. Furthermore, all probe reporting is provided to a central location, if a probe reports an out of normal condition that situation can be identified and addressed.

B. Enviromnental Control Unit

The Environmental Control Unit 1010 can be physically separate from the Growing Unit 1030, 1032, 1034 and controls one or more Growing Units 1030, 1032, 1034 within a Growing Room. The Central Control System 1005 contains the algorithms for managing the Nutritional Formula for each of the Growing Units 1030, 1032, 1034. The algorithms contain the formula's which are transmitted to the Growing Units 1030, 1032, 1034. The Environmental Control Unit 1195 is connected to the Growing Room HVAC System 1020 to receive temperature and humidity sensor data. In a natural light environment such as a Greenhouse or a field, the Environmental Control Unit 1195 will provide commands to ensure the Flexible Lighting Units 900 are raised or lowered to enable natural light to be used on the plants. Natural light is available depending on the position of the sun. For each Growing Unit 1030, 1032, 1034, this may be timed differently for each Growing Unit. Using the placement of the Growing Units 1030, 1032, 1034, the Environmental Control Unit 1195 will address shadows falling on a Growing Unit 1030, 1032, 1034.

C. Connectivity

The entire system can be connected directly via. Ethernet, wire or other protocol, or wirelessly using Wi-Fi, Bluetooth, RF protocol or another protocol. The data connectivity is used to implement the Nutritional Formula through the various components.

D. Growing Unit

The Growing Unit 1030, 1032, 1034 is a single unit consisting of a number of components: Multiple growing planks 310, Nutrient Solution, Nutrient Solution Reservoir 120, Nutrient Solution Movement System, Nutrient Delivery Channel 110, Nutrient Storage Unit 410, Lighting Control Unit 1180, Flexible Lighting Unit 900, Atmosphere Subsystem, System Control Unit 1110. In one current embodiment the Growing Unit 1030, 1032, 1034 has 40 growing planks, 20 on each side. The configuration and number of Growing Planks 310 on each side can be changed, including having the Growing Planks 310 only on a single side. The Growing Plank 310 is locked into position with a key lock system 622, 624 at the top to ensure it does not fall out the plant starts to grow and the plant weight shifts out of the Growing Plank 310 as the canopy develops.

Connected to the Growing Unit 1030, 1032, 1034 are the liquid supply (typically water), electrical power, compressed air, and CO₂.

The Growing Unit 1030, 1032, 1034 physical configuration can change, specifically in the size and dimensions of the growing plank 310. If the configuration is changed, size adjustments to the other components will be changed to reflect the new configuration.

It is anticipated the Growing Unit 1030, 1032, 1034 can be deployed in an uncontrolled inside environment (for example: a restaurant, a home, or a grocery store), a Controlled Agricultural Environment, a greenhouse or a. high tunnel or “hoop” style greenhouse, or outside open to the elements (example: a backyard or a field).

In Growing Mode, the Flexible Lighting Unit 900 will be partially or fully extended depending on the availability of natural light Depending on the Lighting Formula, the LED lights will be turned on or off. Depending on the Atmosphere Formula, the airflow and CO₂ level will be adjusted.

In Harvest Mode, the plants located in the growing planks 310 are intended to be harvested., Therefore, the various Growing Plank 310 subsystems will shut down appropriately to enable the harvesting to occur. The Growing Room temperature and humidity will be reduced to slow plant respiration during harvesting thus increasing shelf life post-harvest. The airflow and CO₂ levels on the Grow Unit being harvested will be adjusted as appropriate.

E. Nutrient Solution Storage

The Nutrient Solution flows through the entire system. When the pump is off, the Nutrient Solution is stored in the four chambers of the Nutrient Solution Reservoir 120, which includes the two Plank Chambers 152, 154, one Catchment Chamber 140, and one Nutrient Pumping Chamber 130. At the bottom of the Nutrient Solution Reservoir 120, are adjustable legs 162, 164, 166 used to ensure the Growing Unit 1030, 1032, 1034 is level in pitch, yaw, and roll. Setting the level ensures correct movement of the Nutrient Solution through the system. The Growing Plank 310 may be placed into the Growing Unit 1030, 1032, 1034 on an angle with bottom in front of the top for two reasons (a) The angle is intended to ensure Nutrient Solution stays within the Growing Plank 310 and (b) the Growing Plank 310 remains in place even as the plant grows, and gains weight, and the center of gravity moves out of the Growing Plank 310. The Growing Plank 310 rests on the bottom of the reservoir within the Plank Chambers 152, 154. The Catchment Chamber 140 is behind the Growing Planks 310. The Growing Plank 310 may also be placed into the Growing Unit 1030, 1032, 1034 not at an angle.

F. Growing Unit

Each Growing Plank 310 consists of plant 820 growing in a substrate. In the current embodiment there are two Growing Plank 310 designs a) growing plank—Sandwich Design and growing plank Homogenous Design.

The growing plank Frame 810 holds the contents of the Growing Plank 310 together. The Growing Plank 310 is kept closed by, for example zipties, elastics, or straps attached with a standard strapping machine. The strapping machine is modified with fold points 710, 712, 714, 716 to ensure a square shape is maintained. The straps are to ensure the unit is secure and holds the Organic Grow Media between the Inert Grow Media.

The weight of a Growing Plank 310 is monitored and reported to the System Control Unit 1110. The current weight is used to verify that the plants 820 in the Growing Plank 310 are growing at a correct rate. Once a specific weight has been reached, the Growing Plank 310 is known to be ready for harvest. The weight expectation is part of the formula managed for this purpose by the System Control Unit 1010.

The face of the Growing Plank 310 is coated with a reflective surface 720, 722 to reflect the light from the Flexible Lighting Unit 900 to the bottom leaves and under the leaves. The reflective surface is rough to ensure all light waves are reflected at all angles. It is important to allow airflow into the frame 810 820, The airflow can enter from the top, or alternatively apertures can be placed on the back side, or air tubes with apertures can be placed directly inside the grow plank 310 connected to the compressed air system 1199.

The height of the Growing Plank 310 can be any height. In the current embodiment, the Growing Plank 310 is eight (8) feet tall with 4 inch left, right, and back sides. The front is 4 inches wide, and each side is 1.75 inches with a ½-inch gap. The plant grows through the gap. The gap can be changed to accommodate the width of the shoots of a Variety. Changing the Growing Plank 310 height and shape will change other dimensions in the Growing Unit 1030, 1032, 1034. The frame 810 is currently embodied in a folded corrugated plastic unit. The frame material is cut and scored to enable folding and bending prior to being used. The fold points 710, 712 714, 718 must leave a space at the front of the plank to allow the shoots of the plants forming the canopy to grow from the root structure 830. The typical width of the space for most herbs and leafy greens is a ½ inch space. Many vegetables will grow in a square shaped 4-inch by 4-inch Growing Plank 310, This embodiment reduces the manufacturing cost, integrates the transplanting and sandwich manufacturing as a single step, and provides the pressure on the sides of the sandwich. The shape of the Growing Plank 310 is adjusted for the type of plant and root system needed. For example, a carrot will require an 8-inch×3-inch wide Growing Plank 310, while a fruit tree would require a square Growing Plank 310 of 2 feet by 2 feet. The depth and width of the Organic Grow Media and the Inert Grow Media must provide enough space for the roots to provide anchorage for the plant. If the Growing Plank 310 dimensions are changed, the dimensions of the other components in the Growing Unit 1030, 1032, 1034 will also be changed.

The Growing Plank 310 is internally structured much like a sandwich with Inert Grow Media on either side and Organic Grow Media in the middle. The Inert Grow Media is a steel wool like pH neutral plastic. The Organic Grow Media is composed can be a mixture of soil, coconut coir, peat moss, perlite, vermiculite, and sand with the formula specific to the Variety being grown. Any component can be zero to 100% of the Organic Grow Media. The formulation of the Organic Grow Media is best made specific to the particular Variety due to the unique nature of its root structure. The Organic Grow Media is intended to maintain moisture while wicking Nutrient Solution downwards using a capillary action. The root system is within the Organic Grow Media and extends into the Inert Grow Media. The Nutrient Delivery Channel 110 delivers Nutrient Solution into the top of the Growing Plank 310, starting the capillary action in Organic Grow Media as well as cascading Nutrient Solution through the Inert Grow Media. The Organic Grow Media provides nutrients via a technology including a traditional fertigation system and a Hydroponic Wicking and Ebb and Flow system. The Inert Grow Media provides Nutrient Solution encompassing Hydroponic NFT and Water Culture technology. The Organic Grow Media and the Inert Grow Media enables a full root system. The Organic Grow Media ensures that in case of a failure of the Nutrient Solution Flow Cycle, the roots will have water (Nutrient Solution) available. The time without Nutrient Solution replenishment is expected to be five days, with the specific length of time is dependent on the cultivar, the stage of growth, and the volume of Organic Grow Media in the Growing Plank 310 configuration.

In one method of planting in the Growing Plank 310, plants are grown using traditional methods until the first real leaves have appeared, which is approximately 2 inches in height. The frame material for the Growing Plank 310 is placed in a jig with a ½ inch lip at the front and the remainder of the frame material standing upright forming a channel. The Inert Grow Media is placed on the frame material with channel. The Inert Grow Media fits the channel perfectly from front to back. Organic Grow Media is placed on top of the Inert Grow Media. In the current embodiment, ½ inch height of Organic Grow Media is placed, the actual amount, dependent on the variety and configuration of the Growing Plank 310. Plants are placed on the Organic Grow Media spaced appropriate to the Variety. A covering of a ½ inch of Organic Grow Media is placed on plants. The top Inert Grow Media of the same size is placed on top of the Organic Grow Media. The frame material is wrapped around the sandwich which now forms a Growing Plank 310. The Growing Plank 310 is strapped to ensure its square and consistent in size.

In the Homogenous Design the contents of the Growing Plank 310 are a consistent Organic Grow Material. There may or may not be Inert Grow media placed at the top, bottom and places along the middle to ensure the Organic Grow media does not fall out the bottom. The Organic Grow media can be any of the Soilless Material described in the Growing Plank 310—Sandwich Design.

A method of creating a planted Homogenous Design has been created. based on soilless media comprising primarily of Coconut Coir. Coconut Coir (CC) is a natural fiber extracted from the husk of coconut. CC is the fibrous material found between the hard, internal shell and the outer coat of a coconut. CC comes from the manufacture as a compressed substance that can be cut in a manner with a sharp blade easier than cutting wood. When water is added to the CC, it expands with each manufacture's CC expanding at a different ratio. In the current embodiment, the CC tested expanded at 4× ratio and the measurements following use this expansion ratio. If a CC has a different expansion ratio, the measurements must be adjusted. The frame 810 material is folded along its back fold 714 716 creating a U shape. The bottom of the U will have a 4-inch base. The Frame 810 is placed into a Jig holding it in position. The CC is cut into a strip 7 feet long. 4 inch-wide, 1 inch high. (If a 7′ strip is unavailable, smaller strips can be used and placed side by side to create the 7″ strip). The strip is placed flat into the U-shaped Frame along the bottom of the U. Seeds are placed according to the variety spaced appropriately to the Variety. A second 7′×4″×½″ strip is placed on top of the seeds. The entire Growing Plank 310 is strapped together, while maintaining the square shape. The Growing Plank 310 is placed into the Growing Unit 1030, 1032, 1034. When the Nutrient Solution is fed into the Growing Plank 310 from the Nutrient Delivery Channel 110, the CC will expand and fill the entire Growing Plank 310. The CC can be manufactured in a tongue and groove manner to enable the top CC to fit into the bottom CC. The seeds are placed in the groove part and held in place by the tongue of the CC. This same method can be used for any other soilless media that comes in a compressed form that is uncompressed with addition of liquid.

Another alternative planting method is created with expanded CC and a seed tape placed on top prior to the closing of the Growing Plank 310. If the CC is not mixed with another media, such as perlite, inert media needs to be placed in different spacing to support the coconut coir. Inert media is placed at the top to spread the nutrition formula across the entire area of the growing plank, inert media is placed at the bottom to keep the soilless media from falling out.

Another alternative method is if seeding is prior to expanding CC. Prior to being placed in the frame, or after being placed in the frame, a device creates a hole in the CC. The hole can be created with a drill bit, or punctured by an extremely sharp pin. The seed is placed in the whole by another device. The hole is optionally filled by another device. The filling is dependent on the Variety and/or if the seed will fall out during handling. The depth of the placement of the seed will be dependent on the Variety and the expansion of the CC. The same method may be applied to any other organic or non-organic grow media that expands even slightly in water.

G. Nutrient Reservoir Chambers

There are four chambers within the reservoir: two Plank Chambers 152, 154, one Catchment Chamber 140, and one Nutrient Pumping Chamber 130. The Catchment Chamber 140 is located between the Plank Chambers 152, 154, the pump area is in the Nutrient Pumping Chamber 130 at the end of the Catchment Chamber 140. Each chamber is completely sealed so that the Nutrient Solution can only move from one area to another over a weir 240, 242, 244 separating the chambers. The Nutrient Solution moves from the Plank Chambers 152 154 to the Catchment Chamber 140, and from the Catchment Chamber 140 into the Nutrient Pumping Chamber 130.

H. Weirs and Dividers

The Nutrient Solution moves over a weir 240, 242, 244 between each of the chambers which is used to slow the movement of the Nutrient Solution and to enable debris to settle in each chamber. The weir height between the Catchment Chamber 140 and the Pump Chamber 130 is lower than the weir height between the Plank Chambers 152, 154 and the Catchment Chamber 140. The height of the weirs will ensure the minimum amount of debris reaching the Nutrient Pumping Chamber 130. The weir between the Plank Chamber 152, 154 and the Catchment Chamber 140 is located opposite end of the Nutrient Pumping Chamber 130 to ensure the Nutrient Solution must flow the entire distance of the Catchment Chamber 140. Within the Catchment Chamber 140 there are three dividers 261 262 263 that are the width of the Catchment Chamber 140. The dividers 261 262 263 may have openings within each of them representing less than ½ the width area of the Catchment Chamber 140. The reduced-width openings are intended to slow the movement of the Nutrient Solution within the Catchment Chamber 140. The openings may also be placed in different locations with the dividers 261 262 263 to further slow the movement of the Nutrient Solution. In the current embodiment, there are three dividers; others can be added as necessary. The total volume of Nutrient Solution in a Growing Plank 310 should never overflow the walls of the chambers or the walls of the Nutrient Solution Reservoir 120.

I. Nutrient Solution

The Nutrient Solution is pumped from the Nutrient Pumping Chamber 130 to the Nutrient Delivery Channel 110. During the pumping, nutrients are added to the Nutrient Solution as per the Nutritional Formula required at that point in time. The nutrients can be added in liquid, solid, or water soluble form. The Nutrient Solution is intended to be added as close to the delivery to the Growing Plank 310 as possible to ensure the greatest infusion of nutrients into the liquid and as close to the delivery to the plants as possible. In the Nutrient Delivery Channel 110, the Nutrient Solution is put through multiple apertures 510 into individual growing planks 310. Through gravity, the Nutrient Solution enters the Growing Plank 310 exiting from the bottom of the Growing Plank 310 into the Plank Chambers 152, 154 of the Nutrient Solution Reservoir 120. When the Nutrient Solution level rises above the weir between the Plank Chambers 152, 154 and the Catchment Chamber 140, the Nutrient Solution overflows over the weir into the Catchment Chamber 140. When the level of the Nutrient Solution rises above the weir between the Catchment Chamber 140 and the Nutrient Pumping Chamber 130, the Nutrient Solution overflows into the Nutrient Pumping Chamber 130, where the cycle begins again. When the pump is active, the Nutrient Solution will be continuously flowing from one chamber to the next. The movement of the Nutrient Solution is intended to a) increase the level of dissolved oxygen, and b) reduce the possibility of algae forming in the Nutrient Solution.

The Nutrient Pumping Chamber 130 pumps Nutrient Solution under control of the Nutrient Control System 1160. During the pumping, the Nutrient Solution receives Dissolved Oxygen, p1-I adjustment, and Plant Nutrients. The pH is increased with one solution and decreased with another solution. Different nutrients are added based on formula provided by the Nutritional Formula. In the current embodiment, nutrients from three different storage containers are added. The formula is dependent on the current state of the Nutrient Solution, the Variety being planted, the relative time from and to the next harvest, and the age of the plants. A submerged or an external pump can be used. The pump is selected to ensure that that the Nutrient Solution is continuously moving through the system.

After liquid and Plant Nutrients, the next most important nutrient in the Nutrient Solution is Dissolved Oxygen. In the current embodiment, the dissolved oxygen is injected with the use of a Venturi aerator during the Nutrient Solution Chamber pumping. The Venturi aerator is part of the pump unit itself, or placed between the pump and the outlet into the Nutrient Delivery Channel 110. The target Dissolved Oxygen level is 200% saturation. Optionally, pressurized or pure oxygen can be injected with the Venturi aerator to further increase the dissolved oxygen level. Other aeration methods can be used as appropriate to the variety.

J. Nutrient Reservoir

The chamber, weir, and dividers of the Nutrient Solution Reservoir 120 is designed to a) capture large debris in the Plank Chambers 152, 154, b) smaller debris in the Catchment Chamber 140, c) add Dissolved Oxygen in the Nutrient Solution Reservoir 120. Other methods, such as a filtering mechanism, can be used for capturing the debris. Other methods for inhibiting algae growth, such as an Ultraviolet light box can be used. The Nutrient Pumping Chamber 130 is connected directly the Environment Liquid System with a liquid level valve that opens to enable liquid to be added when Nutrient Pumping Chamber 130 liquid level is below a set amount. The liquid level valve is calculated in advance for the particular configuration. The amount of liquid let into the Nutrient Pumping Chamber 130 is measured and reported to the System Control Unit 1110. The debris is captured in the Nutrient Chamber to ensure that the apertures 510 or pumps or other equipment do not become blocked or damaged.

K. Environmental Liquid System

The Environmental Liquid. System refers to liquid water being used by the Nutritional Solution. This is typically water from a well, city water, or water coming from a Reverse Osmosis (RO) system. Other non-typical liquids may be used. The Nutrient Solution Reservoir 120 has a valve under control of System Control Unit 1110 which will allow the Nutrient Solution Reservoir 120 to be emptied. It can be emptied into an RO system, thus allowing the Nutrient Solution to be cleaned of unnecessary ions such as Na. When emptied into the RO system, the system is fully recycling all liquid and all nutrients. The frequency of the Nutrient Solution being emptied is dependent on the specific Nutrient Solution the Varieties grown and the nutrients contained in the source liquid being used.

L. Nutrient Control System

The Nutrient Control System 1160 receives instructions from the System Control Unit 1110. These instructions indicate the volume of nutrients to provide to the Nutrient Solution. In the current embodiment, there are three primary nutrient containers, two nutrients containers, and oxygen inserted into the nutrient mix. The Nutrient Control System 1160 will send electronic messages (alarms) to the System Control Unit 1110 when the system is out equilibrium. The anticipated messages include but are not limited to low nutrient levels in any nutrient containers, lack of nutrient flow, lack of fresh water, and low water level.

M. Nutrient Delivery System

The Nutrient Delivery system contains two chambers, a Probe Chamber 520 and Nutrient Delivery Channel 110. The Nutrient Delivery Channel 110 contains the Nutrient Solution prior to its being delivered to the Growing Planks 310. A weir is used to separate Probe Chamber 520 from the Nutrient Delivery Channel 110 and to further add dissolved oxygen and capture debris that may accidently entered the Nutrient Delivery Channel 110. The Nutrient Delivery Channel 110 is sized to create a weight pressure from the water to force the nutrients through the apertures above the Growing Planks 310. The Nutrient Delivery Channel 110 has heating and cooling coils located in it to raise and lower the water temperature under control of the System Control Unit 1110 to achieve the Root Water Temperature. The change in the temperature is required for maximum efficacy for root growth. The temperature must be managed as Dissolved Oxygen density is less with greater water temperature. An overflow pipe is used to return excess Nutrient Solution to the Nutrient Pumping Chamber 130 in case the Nutrition Chamber overflows due to the apertures being plugged with debris. The overflow pipe enables an oversized pump to be used.

In a current embodiment, the Nutrient Solution is dispersed into the Growing Plank 310 through nine apertures 510 positioned such that when the Growing Plank 310 is a sandwich design, three apertures 510 are above the Organic Grow Media, and apertures 510 above each of the Inert Grow Medias. The apertures 510 are positioned the same for both Growing Plank 310 designs. The size of each aperture is such that the amount of Nutrient Solution can be distributed among all the Growing Planks 310 and a deep enough level is maintained for heating/cooling in the Nutrient Delivery Channel 110. The apertures 510 are flat, as opposed to “dimpled” (raised or lowered) to ensure that small debris do not gather in the Nutrient Delivery Channel 110 and eventually block the apertures 510. In one embodiment, the apertures 510 deliver Nutrient Solution directly into the Growing Plank 310. The sizes of the apertures 510 are determined in connection with the pump to ensure adequate Nutrient Solution in the Nutrient Delivery Channel 110 at all times. In an alternative embodiment to the apertures 510, the nine apertures 510 are replaced with a Venturi style aerator. The Nutrition Solution is pulled into the Venturi aerator via gravity and mixed with air (or pure oxygen or any other gas) possibly under pressure thus increasing the dissolved oxygen in the Nutrition Solution prior to entering the Growing Plank 310. The Venturi aerator distributes the Nutrition Solution over the entire Growing Plank 310 area. Any other method of aerating the Nutrient Solution while distributing the Nutrient Solution would also be acceptable, such as for example, a shower head,

N. Probe Channel

The Probe Chamber 520 contains multiple probes, depending on the manufacturer, some probes can be combined. In the current embodiment, the probes report pH, DO, EC, temperature and ions. The ions are currently reported using ISE probes. The specific ISE probes selected are based on the Variety being grown in the Growing Plank 310. The probes are connected to the System Control Unit 1110 and report the status of key elements of the Nutrient Solution. The Probe Chamber 520 is located far enough away from the pump and other electronic devices to ensure there is no electrical interference. The distance dependent on the selected probe technology.

O. Lighting Subsystem

The Lighting Subsystem provides light to the plants. In the current embodiment, the Lighting Subsystem consists of a Lighting Control System and two Flexible Lighting Units 900, with one Flexible Lighting Unit 900 for each side of the Growing Plank 310, each side being termed a Growing Wall. The Lighting Control Unit manages the Lighting Formula specified provided by the System Control Unit 1110.

The Flexible Lighting Unit 900 is designed similar to a roller shade. In the current embodiment, LED lighting strips 920 are attached in a horizontal manner to the shade. The LED strips 920 and shade form the Flexible Lighting Unit 900. The unit is constructed in a manner similar to the following: (1) Attached to the shade (sown or glued or somehow other mechanically connected) to the shade is a plastic casing. (2) The LED strip is attached via glue or other method to an aluminum metal strip. (3) the aluminum metal strip is slid or snapped into the plastic casing. The purpose being that the plastic is a secure attachment to for the aluminum and allows the aluminum component to be removed and replaced. The Aluminum metal strips acts as the heat sink for the LED light strip. The aluminum can be replaced with any other material that can act as a heat sink. Power is provided at alternate ends of the LED strips, thus balancing the power strips to alternate ends of the shade enabling the shade weight to remain balanced. Other power connections are anticipated, such as a flexible LED board using circuit lines. The snap in mechanism enables the LED light strip to be replaced in the field or change the LED strip to a LED strip with a different lighting enhancement.

The Flexible Lighting Unit 900 has two (2) embodiments (a) a fixed position and (2) a moveable position. The choice is dependent on the Variety and the deployment. In the moveable version the Flexible Lighting Unit 900 can be positioned as close to the plant canopy without the heat of the lights damaging the plants. With the LED technology in the current embodiment, this is limited to within 1 inch of the plant canopy. As the plants grow, the Flexible Lighting Unit 900 is moved horizontally away from the Growing Plank 310, when the plants are harvested and shorter, the Flexible Lighting Units 900 moves in towards the Growing Plank 310 and plant canopy. When under automated control, the Flexible Lighting Unit 900 is directed by the System Control Unit 1110. If an automated embodiment, a camera or other sensor can be used for horizontal positioning. The entire Flexible Lighting Unit 900 must be removed for harvesting. To remove it, the Flexible Lighting Unit 900 is rolled over rollers 910, 912 manually or with automated motors. When automated motors are used, they are the under control of the System Control Unit 1110. In the current embodiment, the Flexible Lighting Unit 900 is attached the Growing Unit 1030, 1032, 1034 in one of two configurations dependent on the intended deployment of the Growing Unit 1030, 1032, 1034. For deployment in a Controlled Agricultural Environment, the Flexible Lighting Unit 900 is attached to the bottom of the Nutrient Delivery Channel 110 and the blind unrolls downward. For a deployment where natural lighting is available, such as in a greenhouse or a field, the Flexible Lighting Unit 900 is attached to the top edge of the Nutrition Solution Reservoir and rolls upwards. When rolled up, the Flexible Lighting Unit 900 is out of the way for harvesting. The upward movement allows plants that are shaded from natural light to receive artificial light. The unrolling of the blind will be controlled by the System Control Unit 1110 based on the position of the sun and obstacles causing shade on the bottom of the Growing Unit 1030, 1032, 1034. In a partially unrolled environment, only LED strips visible to the canopy will be powered. The purpose of the flexible lighting system is to remove the lighting system and provide access to the plants. Other methods such as a pleated shade or moving the lights vertically above the Grow Unit 1030, 1032, 1034 also achieve the same purpose.

In one current embodiment, each Flexible Lighting Unit 900 produces 90,000 lumens of light on each wall using 21 LED strips 920. The LED strips 920 are at 6500K light spectrum; the LEDs are spaced at 130 LEDs/foot. It is envisioned that LED technology will change and evolve and thus the number of strips, the size, the spacing of the LED's, the Lumens available will change and thus the Lighting Formula will be adjusted to reflect the embodiment of the specific design. It is anticipated that the LED color selection (6500K) will be alternately changed to another color appropriate to the Variety Selected based on test data.

P. Atmosphere Subsystem

The Atmosphere Subsystem provides monitoring and control of the atmosphere for the plants. Atmospheric Sensors will include a camera and sensors for air temperature, humidity, air movement, and CO₂ levels. The Atmospheric Sensors will report the values to the System Control Unit 1110. The temperature and humidity sensor data can be converted into a VPD measurement. The System Control Unit 1110 will provide a formula for air flow, release of the CO₂ into the plants. Airflow is provided by fans and or compressed air sources. Fans and compressed air outlets are located behind the Growing Planks 310, as well as below and above the face of the Growing Planks 310, regular or compressed air outlets may also be placed on the Flexible Lighting Unit 900, The direction of the airflow can be adjusted as (a) CO₂ will also be released from the air outlets and as CO₂ is heavy and falls, and (b) heat rises and the VPD at the top of the tower is lower than at the bottom, therefore more airflow may be required higher up the Growing Plank 310, c) pollination may require a circular or random airflow. A camera or other sensor can be used to detect insect movement, automated tracking of plant growth, and allow inspection of the plants while the Flexible Lighting Units 900 is blocking access. The Flexible Lighting Unit 900 is designed to ensure the CO₂ is kept within the plant canopy. As CO₂ greater than 1,500 PPM is considered dangerous to humans. System Control Unit 1110 can inhibit the opening of the Flexible Lighting Unit 900 to ensure CO₂ remains within the area of the plants and inhibit human access.

Q. Nutrition Storage Unit

The Nutrition Storage Unit contains local storage of pH nutrients to enable the increase/decrease of the pH in the Nutrient Solution, the Major and minor nutrients in the solution. CO₂ will be located either in the unit, or connected to the airflow system or compressed air system.

R. Stored Electrical Power

The Growing Room or Growing unit system may contain a battery backup storage system which will be charged at lowest cost times (expected to be evenings and weekends). The unit will run on battery power during high cost periods. The system will be able to detect unavailable power and switch into a low power mode. This capability can be deployed in locations with inconsistent power such as the artic conditions, dessert climates, war zones, in space, or at sea in ships and submersibles.

S. System Control Unit

The System Control Unit 1110 receives the data values from the Nutritional Probes, the Nutritional Solution Pump, and the Atmosphere Sensors. Based on the values received and the Nutritional Formula, the System Control Unit 1110 will instruct the Nutritional Control Unit, Lighting Control Unit, and the Atmosphere Control Unit. The System Control Unit 1110 will be connected wirelessly to the Environmental Control Unit 1010 and to the Central System 1005. It will report on a regular basis the values of its sensors and will receive wirelessly the formula, management software, and changes to the Nutritional Formula. The Central System 1005 or the System Control Unit 1110 determines a) when the productivity of a Growing Plank 310 is on the decline and should be replaced or b) when the Nutritional Solution has accumulated too many salts and the Grow Unit 1030, 1032, 1034 must be drained and a new Nutritional Solution added.

T. Environmental Control Unit

The Environmental Control Unit 1010 will monitor messages (alarms) from each Growing Unit 1030, 1032, 1034. For example, the Environmental Control Unit 1010 anticipate through its algorithm, when the Nutrient Levels are low, if however, it receives a message that a nutrient level in a specific container is low, there is the possibility of a physical failure in the unit. The failure will require a maintenance check of the unit. Some potential causes of the failure could a. process unit failure, a Nutrient Container not refilled correctly, nutrient amounts are not being dispensed correctly, plants growing slower or faster than anticipated, or leaks in the system.

U. Growing Room HVAC System

The Growing Room HVAC system is a critical technology to the Growing Room. Certain cultivars do better in different in different temperatures. Basil likes a higher temperature and Relative Humidity than does Tomatoes. Kale prefers a dry and almost freezing temperature for maximum taste and growth. The Growing Room temperature is adjusted during the harvest time to minimize respiration after harvest and the returned to its Growing Formula temperature after the harvest is complete.

III. Objectives of the Embodiments

As set forth below, the embodiments described above will achieve numerous improvements to the environment, improvements in crop yields and improvements in re efficacy of growing Varieties.

A. Improved Environmental Effects
The embodiments reduce or remove the need for herbicides, insecticides to remove any loss in the growing of a cultivar, fungicides to remove any loss in the growing of a vegetable. The embodiments remove the need for or a GMO seed to maximize production of a vegetable.
The water in the system continually circulates and will have little or no impact on the environment when in normal operating conditions.
The system provides highly oxygenated enriched Nutrient Solution to the plants complete root structure.
The roots receive continuous and complete nutritional solution which is adjusted to correspond with their growth stage, the lighting parameters of the moment, and the atmosphere at the moment.
The system reduces or removes the need to be drained or flushed, only refreshed with nutrients, dissolved oxygen, and liquid.
The nutritional solution can be adjusted to reflect the nutrients in the source liquid (well water compared to city water, compared to rural water).
The system will deliver consistent growth in all weather conditions such as droughts, floods, hurricanes, tornados, hail storms, heat waves, frost conditions, snowstorms, and thunderstorms.
The system can self-adjust for all growth parameters and all desired Cultivar measurements
Disease spread can be limited to Growing Planks 310, Growing Units 1030, 1032, 1034, or Growing Rooms depending on the form and type of disease.
The Flexible Lighting Unit 900 can provide a barrier for the spread of airborne disease to other Growing Units 1030, 1032, 1034.
Insect infestation can be controlled by massive increases in CO₂ level while maintaining human safety beyond the Flexible Lighting.
The Organic Grow Media enables organic certification in countries, like Canada, which require the roots to be grown in a natural media.
The frame, in the current embodiment, is made of a bendable plastic, enables the frame to be created as the plants are transplanted into the sandwich and folded around.
The embodiments when deployed in a controlled agriculture environment with correct proper procedures will be insect free.
The Flexible Lighting Unit 900 provides a barrier for CO₂, enabling the plant atmosphere to have a high level of CO₂ while the room atmosphere to remain at a much lower safer level.
The embodiments will be able to produce vegetables in adverse conditions such as frequent power outages and low power conditions.
Direct harvest to packaging limits the need for ethelyne management to the contents of the mixed salad.
The typical source of pathogens is through workers, raw materials and airflow through the HVAC system. These are reduced or eliminated as there is limited access of contaminates (such as animals or impure bodies of water) within the described environment.

B. Improved Yield
In the currently described embodiment, as a rule of thumb, the plant spacing per linear foot is 4 times greater that than traditional planting or hydroponic planting. The plant density is 21-28 times greater per square foot. These increases can be greater or lower depending on the particular Variety and on the desired Cultivar Measurement Factor. The current embodiment of the Grow Unit 1030, 1032, 1034 is expected to achieve or grow more within a single year the same amount of vegetable weight that an acre of land would achieve using modern farming techniques.
The embodiments enable production quality and quantity cut-and-come again harvesting. In the current embodiment, 26 to 52 harvests with consistent weight yields per harvest can occur per year.
The embodiments enable detailed tracking of the plants usage of water, nutrient mix, usage of light, and atmosphere that creates a specific Growing Formula for a cultivar. The formula for a cultivar changes based where it is in the growth cycle, how many days from harvest. (A plant will require one nutrient immediately post-harvest to repair itself and another once it begins the photosynthesis cycle.)
Plants in each Growing Plank 310 will grow consistently, meaning each plant will reach maturity be ready for harvest at the same time because the plants all receive consistent light, Nutrient Solution, are planted in at the same time in terms of their growth level, they are planted in the Growing Sandwich media at the same depth, receive a consistent atmosphere, and are harvested in a consistent method.
The embodiments allow each plant to be at a specific maturity providing a consistent harvest.
The embodiments allow for automated harvesting.
The growth cycle from seed to harvest is significantly shortened as compared to traditional farming and hydroponic farming.
The Invention enables the growing of vegetables that are considered Kosher at harvest time as there is no expectation of insect infestation since ingesting insects is forbidden under Jewish law).
Vegetables are harvested in atmospheric and climatic conditions designed for longer shelf life while maintaining targeted levels of Cultivar Measurement Factors.
Harvesting methods enable both harvesting and the cutting for Ready-To-Eat salads.
The embodiments enable the vegetables to be harvested and eaten, removing the need for washing vegetables prior to packaging or prior to eating.
The time between harvesting and being in a sealed packaged container can be less than 15 minutes.
The ability to control the temperature which harvesting is performed in will reduce or remove vegetable damage due to chilling the vegetables after harvest and before packaging.
Once in a package, there will be significant reduction in weight loss as relative humidity will remain constant.
The Growing Formula can be designed to purposely stress the plants to induce flowering, for example, Nitrogen deficiency in tomatoes is considered a consistent method to induce flowering and which grow tomatoes. Once flowering has occurred, the tomatoes require nitrogen to grow. The deficiency can be timed to ensure maximum and consistent fruit bearing. Other known types of stress that can be induced include: Specific nutrient deficiencies (Iron, calcium, etc.). Liquid deficiency or abundance, Light deficiency or over abundance, and Atmosphere deficiency or abundance.
The growing plank design can have its size parameters adjusted in a way suitable for any cultivar, enabling large fruit bearing trees to be grown.
The high level of the Dissolved Oxygen ensures the maximum possible take-up of nutrients by the plants.
The system enables the maximum yield possible to be found for any Variety.
The Growing Room environment can be adjusted to further any specific the Cultivar Measurement Factor.
The consistency of growing, enables Growing Units 1030, 1032, 1034 to be deployed to grow the same cultivar using the same seeds without the probes and sensors within the same Growing Room, as the growth as predicted by the Growing Formula can be monitored by one a single Growing Plank 310. The seeds and transplanting must be performed at the same time as the single control unit.

C. Improved Operations
There is no single catastrophic failure point in a Growing Unit 1030, 1032, 1034. The most significant failure is loss of electricity to the unit, which will mean the pump will fail, no nutrients will be added to the Nutrient Solution, and the Flexible Lighting Unit 900 will remain dark. The plants will be able to continue to grow for many days before dying, as the Growing Plank substrate will maintain moisture and Nutrient Solution. The length of time is dependent on the Variety and where the plant is in the growing cycle.
There are no continuously moving parts. Parts only operate during to change the conditions of the growing environment of the plants. For example, values in the Nutrition System will open/close to change nutrition or pH levels of the Nutrition Solution. The External Liquid Valve will open bringing in fresh liquid when the Nutrition Solution level is too low, the Flexible Lighting Unit 900 motor will engage to allow access to the cultivars for the purpose of harvesting, the Flexible Lighting Unit 900 will move out as the cultivars grow, and the pump will operate to deliver the Nutrient Solution.
The Growing Units 1030, 1032, 1034 can be adjusted to enable deployment in height location, the only limitation being, an economic one.
Scheduling of growing, harvesting, and delivery can be determined with extreme accuracy.
Volumes of vegetables can be accurately predicted to the day for harvesting. This is irrespective of weather conditions or seasons of the year.
Vegetables of any kind can be grown irrespective of the longitude or latitude of where the Growing Unit 1030, 1032, 1034 is placed when in a Controlled Agricultural Environment. Basil and strawberries can be grown at the North Pole and Kale in the Sahara dessert.
All vegetables of a Ready-To-Eat salad can be grown in the same physical location.
All vegetables of a Ready-To-Eat salad can be harvested and mixed within the same hour ensuring the longest possible shelf life.
The harvesting process can chop the vegetables into the correct size for mixed salads.
The cooling stage of vegetables currently performed prior to packaging is totally removed from the harvesting/packaging process as the Growing Room temperature and humidity can be adjusted to ensure minimum or no damage to the vegetables during the harvesting and packaging step.
The continuous movement of water and the oxy-fertigation through the Growing Unit 1030, 1032, 1034 means algae growth is well-controlled.
The continuous measurement and Growing Formula minimizes the amount of waste nutrients left in the Nutrient Solution.
Plant Nutrient values can be promoted to be consistently beyond existing USDA expectations.
The Growing Unit 1030, 1032, 1034 can be deployed on uneven surfaces.
The Growing Planks 310 can be sized for any type from carrots to trees.
The system has a number of capabilities to identify failure situations: 1) Nutrient usage will generate an expected harvest yield weight at a specific time; 2) Nutrient usage will generate an expected water requirement at a specific time; 3) Nutrient usage will generate an expected Growing Plank 310 weight at a specific time: 4) Liquid usage will generate an expected Growing Plank 310 weight at a specific time; 5) Liquid usage will generate an expected harvest yield weight at a specific time; 6) Liquid usage will generate an expected Nutrient usage; 7) Growing Plank 310 weight will generate an expected water usage; and 8) Growing Plank 310 weight will generate an expected nutrient usage.
The system enables a precise Growing Formula to be developed. Experiments can vary or control: Seed Selection, Sandwich construction parameters, Light parameters, Atmosphere parameters, Nutritional Solution Parameters. Each of the listed parameters can be varied or controlled in time relative to the transplanting/harvesting time cycle.
The Growing Plank 310 will provide continuous moving Nutrient Solution for the root structure with the advantages of Field Irrigation and Fertigation and the advantages of techniques developed with Drip, NFT, Wicking, Ebb and Flow, NFT and Water Culture Hydroponic technology.
The Growing Planks 310 are designed to ensure little or no Nutrient Solution touches the leaves so there is reduced possibility of microbial load or fungus growth on the vegetables.
The Growing Plank 310 ensures as much Nutrient Solution is available to the root structure as possible and the Growing Unit 1030, 1032, 1034 reuses all the Nutrient Solution.
The rapid movement of the Nutrient Solution ensures all the Dissolved Oxygen contained in the Nutrient Solution is not lost to the plants at bottom of the Growing Plank 310.
The Growing Plank 310 will enable the root structure to reach into the Plank Chambers 152, 154 of the Nutrient Solution Reservoir 120 to further enhance growing capability without interfering with the operation of the unit.
The Nutrient Solution volume is primarily controlled by adding water through a single valve using a mechanical adjustment. By maintaining the Nutrient Solution level in the Pumping Chamber, to fixed level, the Nutrient Solution will continue its flow cycle. In case of a power failure, all the Nutrient Solution in the Growing Unit 1030, 1032, 1034 will return to the chambers of the Nutrient Solution Reservoir through gravity and remain static. When the pumping resumes, the Nutrient Solution will first empty from the Pumping Chamber and the Nutrient Solution movement cycle will resume and return to its steady state.
The system will measure and report all the major and minor-nutrients for the growth of the cultivars.
The lighting system formula will enable simulation of morning, midday, evening, nighttime, and all hours in between, for any location and any day of the year for any longitude/latitude thus providing an equivalent lighting season.
The atmosphere system formula will enable simulation of morning, midday, evening, nighttime, and all hours in between, for any location and any day of the year for any longitude/latitude thus providing an equivalent atmosphere season.
The lighting and atmosphere system can be combined and coordinated.
The system enables lights to be as close to the plants as possible at all times, moving in position to reflect the plants growth as needed. The consistent plant growth ensures all plants receive the same amount of light. The is intended to ensure all energy used for lighting provides maximum efficiency of the energy used within the system. The actual energy to grow the vegetable can be reliably calculated. This energy will be the sum of the energy load of the operation of the invention, the energy load of all the nutrients added to the system and the energy load required to create the seeds. Added to this sum can be an amount to amortize the building of the machine.
The reflective material on the Growing Plank 310 ensures lower leaves receive light as the hack of the leaves.
The embodiments minimize light energy lost. This attempts to achieve the greatest amount of photosynthesis possible by the plants.
The Growing Formula will be able to predict when the plant Cultivar Measurement Factors have deteriorated below the expected level and Growing Planks 310 should be replaced with new transplanted plants.
The design of the Flexible Lighting Unit 900 enables simple and easy replacement of the LED strips in the field. The strip can be slid out and a new strip added.

D. Variations

Without limitation, the various components described above may be deployed in different configurations, including:
The Grow Unit 1030 1032 1034 may be deployed outside a grow room or in a grow room without an HV AC Unit.
The Grow Unit 1030 1032 1034 may be deployed without the Flexible Lighting Unit 1170.

The Grow Unit 1030 1032 1034 may be deployed without connections to compressed air or CO2 or an external liquid source.
The Grow Unit 1030 1032 1034 when deployed without the lighting system may be deployed in a location providing full natural or artificial light or partial natural light or artificial light. An optimal deployment may have the full grow plank 310 receiving light.
The spacing between Growing Units 1030 1032 1034 when deployed may provide enough spacing to enable a person to enter between the Growing Units 1030 1032 1034 to all them to harvest the vegetables.
The spacing between Grow Units 1030 1032 1034 when deployed and receiving light from a source other than the Flexible Lighting Unit 1170 may take into account shadows falling on the Grow Plank 310.
The Growing Units 1030 1032 1034 may be placed on a movement system, such as a roller bearings, wheels, or other movement object to allow the space between the grow units to be reduced.
It is anticipated that a shipping container may be used as a Grow Room with Growing Units 1030 1032 1034 deployed on the movement system.

IV. CONCLUSION

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, The term “coupled” as used herein is defined as connected, although not necessarily directly and not necessarily mechanically. A device or structure that is “configured” in a certain way is configured in at least that way, but may also be configured in ways that are not listed. The terms “vegetable”, “leafy green”, “salad” include grains, grasses, herbs, fruits plants, fruit trees, flowers, and all forms of growing plants.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1-27. (canceled)

28. A system, comprising:
a) a plurality of plants with roots in a self-contained plant unit placed vertically such that shoots exit the self-contained plant unit horizontally towards a lighting unit placed vertically and somewhat parallel to the self-contained plant units and water and nutrients are supplied to the roots from the top of each of the self-contained plant units, and
b) a plurality of plant units located in a single growing unit comprising:
a water reservoir maintained a specific height and connected to a water supply unit that adds water as water height is lowered;
a system which continuously monitors and adjusts water temperature, pH level, dissolved oxygen level of the water delivered to plant roots;
a system which continuously monitors and adjusts macro-nutrient and micro-nutrient levels in the water;
a system which continuously monitors and adjusts CO₂ level, temperature, humidity, VPD, airflow direction, and airflow speed being delivered to the plant canopy;
a system which continuously monitors and adjusts distance of light from the plant canopy and amount of light the plant canopy receives; and
a plurality of growing units contained within a room with positive air pressure containing an HVAC system that monitors and adjust the ambient room temperature and an air filtration system to monitor and remove harmful pathogens from the air,

29. The system as in claim 28, wherein during a repeated plant growth and harvest cycle the amount of macro-nutrients, micro-nutrients, dissolved oxygen level, pH level, humidity, VPD level, CO₂ level, air velocity and air direction, amount of light and light spectrum at a specified distance from the plant canopy is predetermined.

30. The system as in claim 29, wherein the system is to be repeated anywhere on the planet producing the same harvest weight at the same time within the repeated grow and harvest cycle.

31. The system as in claim 29, wherein during a repeated plant growth and harvest cycle the amount of macro-nutrients, micro-nutrients, dissolved oxygen level, pH level, humidity, VPD level, CO₂ level, air velocity and air direction, amount of light and light spectrum at a specified distance are adjusted to provide repeatable results for plant taste at a specific time in the growth and harvest cycle.

32. The system as in claim 29, wherein during a repeated plant growth and harvest cycle the amount of macro-nutrients, micro-nutrients, dissolved oxygen level, pH level, humidity, VPD level, CO₂ level, air velocity and air direction, amount of light and light spectrum at a specified distance to provide repeatable results for plant nutrition.

33. The system as in claim 29, wherein the system prevents pathogen spread between plants.

34. The system as in claim 28, wherein the plants can live for several days if there is no electricity supplied to the system.

35. The system as in claim 28, wherein the vertical lighting panel system is used to direct the airflow.

36. The system as in claim 28, wherein the vertical lighting panel system is used to keep CO₂ within the plant canopy.

37. The system as in claim 28, wherein the airflow is used to increase turgidity of the plant shoots.

38. The system as in claim 28, wherein the airflow moves the heat generated by the lighting panel to a place beyond the lighting panel.

39. The system as in claim 28, wherein the system reduces the spread of pathogens to people from the plants grown.

40. The system as in claim 28, wherein yield is further increased by only harvesting the canopy and not the roots.

41. The system as in claim 28, wherein the plants can be certified kosher and insect free without the use of insecticides.

42. The system as in claim 28, wherein the CO₂ level can be raised to a level to kill insects while the lighting panel ensures the CO₂ does not enter the general area of the room.

43. The system as in claim 28, wherein the lighting panel can be adjusted to allow natural light to access the plant canopy.

44. The system as in claim 28, wherein the only moving continuously moving part required for operation is the pump.

45. The system as in claim 28, wherein the system is self-enclosed and only discharges into the environment oxygen from the plant canopy.

46. The system as in claim 28, wherein the reservoir has a series of weirs and storage areas to capture debris from the roots.

47. The system as in claim 28, wherein the plant canopy is grown without any pesticides, fungicides, or herbicides.
